(19) United States
(12) Patent Application Publication
(10) Pub. No.: US 2026/0173069 A1
(43) Pub. Date: Jun. 18, 2026

(54) METHODS AND DEVICES TO PERFORM SATELLITE COMMUNICATION

(71) Applicant: Intel Corporation, Santa Clara, CA (US)

(72) Inventors: Peng LU, Elk Grove, CA (US); Michael BEADLE, Tustin, CA (US); Niall POWER, Newcastle West (IE); Ashwini BHAGAT, San Diego, CA (US); Samuel WONG, San Diego, CA (US); Thushara HEWAVITHANA, Chandler, AZ (US)

(21) Appl. No.: 18/985,169

(22) Filed: Dec. 18, 2024

(51) Int. Cl. H04W 72/1263; H04L 5/14; H04W 56/00; H04W 64/00; H04W 72/0446; H04W 84/06

(52) U.S. Cl. CPC H04W 72/1263; H04L 5/1469; H04W 56/009; H04W 64/00; H04W 72/0446; H04W 84/06

(57) ABSTRACT

An apparatus of a network access node, the apparatus may include a memory and a processor configured to: determine a time-division duplex communication pattern including a plurality of time slots for communication between the network access node and a terminal device; allocate first time slots of the plurality of time slots for the network access node to perform uplink and/or downlink communication; allocate a number of second time slots of the plurality of time slots during which the network access node is scheduled to perform neither uplink communication nor downlink communication with the terminal device, wherein the number of the second time slots is based on a round trip time delay of the network access node; and schedule the terminal device to transmit uplink communication signals or receive downlink communication signals during at least one second time slot of the second time slots.

### BACKGROUND

A radio access network may refer to a component of wireless communication networks, which is responsible for wirelessly connecting terminal devices, such as smartphones, tablets, or another user equipment (UE), to the network. The radio access network can include several elements, including network access nodes (e.g. base stations), antennas, and radio transceivers that facilitate the transmission and reception of radio signals between the devices and the network. Base stations can process these radio signals and forward them to the core network for further routing and control. In modern cellular networks, such as 4^{th} generation long term evolution (4G LTE), 5^{th} generation (5G), 6^{th} generation (6G), etc. radio access networks aim to ensure connectivity, managing wireless resources, and maintaining communication quality across large geographic areas.

Non-terrestrial networks have emerged as an extension of traditional radio access networks to include satellite-based communication systems. Non-terrestrial networks are part of the 3rd Generation Partnership Project (3GPP) standards and aim to integrate satellite and terrestrial cellular networks to provide broader coverage, especially in remote or underserved areas. Satellite-based networks may use satellites as additional nodes in the radio access network infrastructure to enable terminal devices and network access nodes to connect via satellite links. Such a connection via the use of satellites may be established when terrestrial coverage is unavailable. These satellite-based networks, such as non-terrestrial networks, may face certain challenges compared to terrestrial radio access networks, such as higher propagation delays and doppler shifts due to the relative motion of satellites. It may be desirable to address these challenges.

### BRIEF DESCRIPTION OF THE DRAWINGS

In the drawings, like reference characters generally refer to the same parts throughout the different views. The drawings are not necessarily to scale, emphasis instead generally being placed upon illustrating the principles described herein. In the following description, various aspects are described with reference to the following drawings, in which:

FIGS. 1 and 2 depict a general network and device architecture for wireless communication;

FIG. 3 shows an exemplary internal configuration of a communication device;

FIG. 4 shows an example of an illustrative diagram showing a satellite communication system with service and feeder links;

FIG. 5 shows an example of a timing diagram illustrating downlink and uplink communication slots;

FIG. 6 shows an example of a timing diagram;

FIG. 7 shows an illustrative diagram of various delay parameters in a network access node and terminal device communication scenario;

FIG. 8 shows an example of a flow diagram in accordance with various aspects described herein;

FIG. 9 shows an example of a flow diagram in accordance with various aspects described herein;

FIG. 10 shows an example of a method;

FIG. 11 shows an example of a method.

### DESCRIPTION

The following detailed description refers to the accompanying drawings that show, by way of illustration, exemplary details and aspects that may be practiced.

Traditional radio communication systems, especially cellular systems such as LTE and 5G NR, are designed mainly for wireless data transfer and communication purposes. Such systems may employ various techniques to enhance data throughput, reliability, and spectral efficiency, including multiple input multiple output, beamforming, and spatial multiplexing. Through the use of multiple input multiple output technologies, multiple antennas at the transmitter and receiver may provide spatial diversity and simultaneous transmission of multiple data streams using the same frequency band. Additionally, beamforming may focus the signal energy towards the intended receiver for the purpose of improving signal quality and mitigating interference. Furthermore, spatial multiplexing may employ the use of diverse propagation paths within the radio environment to transmit multiple data streams concurrently, to increase the overall capacity.

In the field of wireless network communications, networks may utilize time division duplex communication patterns to manage uplink and downlink transmissions between network access nodes and terminal devices (e.g. user equipments). Traditionally, radio communication using time division duplex patterns within a radio access network may include allocating time slots for uplink and downlink communications based on predefined schedules. However, radio access networks may face challenges related to round trip time delays, which can affect the efficiency and reliability of data transmission. Round trip time delays may be influenced by various factors, including the distance between the network access node and the terminal device, and can vary significantly in non-terrestrial networks such as satellite-based networks due to increase of the delay associated with propagation of radio communication signals within the air as the distance increases.

In satellite-based communication, communication devices, which may lack global navigation satellite system capability, may access and communicate via satellite networks. Two prevalent issues in satellite communications may be addressed: i) the significant delay caused by the vast distance between the satellite and the Earth-based device, and ii) the doppler shift and sampling drift resulting from the satellite's high velocity during flyovers. It is to be noted that, without global navigation satellite system capability or knowledge of the satellite's orbit, a device may not precisely ascertain the amount of propagation delay. Also, doppler shift, and sampling drift, may make pre-compensation for these effects unfeasible. Illustratively, the device may be user equipment, a handheld device, or a very small aperture terminal.

When a device that is agnostic of the satellite's orbit attempts to access and communicate through a satellite using a communication technology, such as 4G or 5G cellular technologies, the substantial delay between the device and the satellite can result in missing designated timing budgets for communication, illustratively missing 3GPP telecommunication standards timing budgets known as time division duplex slot format or time division duplex pattern. These time division duplex slot formats can be considered as an agreed pattern of transmission and reception times the network and handset agree upon, each taking turns when to transmit and when to receive. The significant delay can cause a mismatch in device time and the satellite time, causing an overlap of transmission and reception signals, resulting in significant spectrum efficiency loss. Meanwhile, the doppler shift and sampling drift, primarily resulting from the satellite's movement, can lead to severe system performance degradation in orthogonal frequency division multiplexing-based communication systems. This performance loss may affect both time division duplex and frequency division duplexing systems. The doppler shift may refer to the change in carrier frequency that occurs when the satellite moves toward or away from a device. Sampling drift may be the distortion of a time-domain signal, either being compressed or expanded, due to the changing distance between the satellite and the device during signal transmission or reception.

As used herein, round trip time round trip time may refer to the total time it takes for a signal to travel from a source to a destination and back again. In satellite communication, round trip time may be particularly important due to the long distances between Earth-based devices and satellites, often leading to significant delays. In some examples, a round trip time delay may include the propagation delay, which is the time taken for the signal to travel through air and space. Other factors such as processing delays at the satellite and the ground station may further be included. Propagation delay or round trip time delay may be determined by the distance between the satellite and the device, typically measured in milliseconds. For example, in geostationary satellite systems, round trip time can exceed 500 milliseconds due to the distance between Earth and the satellite.

As used herein, time division duplex may refer to a communication method in which uplink and downlink transmissions may occur on the same frequency but at different times. In time division duplex systems, time slots may be allocated alternately for transmitting and receiving data, allowing both directions of communication, which may share the same frequency band. A time division duplex pattern may represent how these time slots are distributed between uplink and downlink within a given frame. In cellular communication context, according to 3GPP standards, time division duplex patterns may be configurable based on network requirements, allowing flexible allocation of resources depending on traffic demands.

As used herein, a time slot may refer to a specific interval within a communication frame during which data transmission or reception occurs. In time division duplex systems, time slots may be divided between uplink and downlink operations. Each time slot may correspond to a fixed duration, such as 1 millisecond in LTE or NR systems, during which either transmission or reception can take place. The number of time slots allocated for uplink and downlink can vary depending on the time division duplex pattern being used. In the cellular communication context, in 3GPP-defined systems like 5G NR, time slots may further be divided into subframes and symbols.

As used herein, doppler shift may refer to the change in frequency of a signal caused by relative motion between the transmitter and receiver. In satellite communications, this effect may become significant due to the high velocity of satellites relative to Earth-based devices. As a satellite moves towards or away from a device, it may cause a shift in the carrier frequency of the transmitted signal. Such a frequency shift can degrade system performance by introducing errors in frequency synchronization, especially in orthogonal frequency division multiplexing-based systems.

As used herein, sampling drift may refer to the phenomenon that occurs when there is a mismatch between the sampling rates of two communicating devices due to relative motion or clock inaccuracies. In satellite communications, sampling drift can result from changes in signal timing as satellites move relative to Earth-based devices. This drift may lead to distortions in received signals because they are sampled either too quickly or too slowly compared to their original transmission rate. Over time, the sampling drift can cause significant degradation in signal quality, especially in orthogonal frequency division multiplexing-based systems where precise timing is critical for maintaining orthogonality between subcarriers.

In conventional time division duplex communication systems, both the terminal device and the network access node (e.g. satellite-based network access node) may follow a symmetric time division duplex slot format, where uplink and downlink transmissions occur within the same time slots for both the terminal device and the satellite. This symmetry can ensure coordination between transmission and reception operations in terrestrial networks, where propagation delays are relatively small. However, in satellite communications, the significant propagation delay caused by the large distance between the satellite-based network access node and Earth-based devices can lead to a timing mismatch between the terminal device's transmission and the satellite's reception. This mismatch may result in an overlap of transmission and reception signals, leading to interference, reduced spectrum efficiency, and degraded communication performance. Such issues may particularly be relevant in non-terrestrial networks, where round trip time delays are much larger compared to terrestrial networks.

In accordance with various aspects described herein, the terminal device and the network access node may use an asymmetric time division duplex slot format to improve spectrum efficiency and mitigate the effects of large propagation delays in satellite-based communication systems to communicate with each other. Unlike traditional symmetric time division duplex patterns, aspects described herein may include an asymmetric allocation of time slots for uplink and downlink transmissions between the terminal device and the satellite access node. Specifically, a generated time division duplex pattern may offset the satellite's transmission schedule relative to that of the terminal device to allow sufficient time for signals to propagate without causing overlap between uplink transmissions from the terminal device and downlink receptions at the network access node. In some examples, a processor may dynamically adjust this offset based on real-time delay measurements or pre-configured delay models to ensure that transmissions and receptions remain synchronized despite varying propagation delays. Accordingly, aspects described herein may facilitate interference reduction, prevent signal overlap, and enhance overall spectrum efficiency in non-terrestrial network environments.

In an example, a processor may schedule a terminal device to perform neither uplink nor downlink communication during at least one time slot based on the round trip time delay. Illustratively, a processor of a network access node may determine a time division duplex communication pattern, in which within a duration defined by a plurality of time slots, the processor may allocate first time slots for the network access node to perform uplink and/or downlink communication while allocating second time slots during which the network access node performs neither uplink nor downlink communication. In some examples, the number of time slots of the second time slots may be based on a determined round trip time delay. In this constellation, the network access node may schedule a terminal device to perform uplink or downlink communication with the network access during at least one time slot of the second time slots. This configuration may address the problem of significant delay caused by the distance between the network access node and the terminal device (e.g. between the satellite and the Earth-based device), which may result in missing 3GPP telecommunication standards timing budgets. By allocating second time slots based on round trip time delay, the apparatus may avoid overlap of transmission and reception signals, potentially improving spectrum efficiency.

In an example, the processor may further schedule the terminal device to perform neither uplink communication nor downlink communication with the network access node during at least one first time slot of the first time slots. By allowing the terminal device to remain idle during certain first time slots, the apparatus may improve overall network efficiency and reduce power consumption for the terminal device by facilitating correspondence for the round trip time delay within the time slots in which the network access node is scheduled to perform uplink or downlink communication.

In an example, the processor may determine the round trip time delay based on a location of the terminal device. In view of the network access service provided by the network access node to multiple terminal devices within a coverage area; the round trip time delay may have a common round trip time delay component that is determined for the multiple terminal devices within the coverage area, which is applicable to all terminal devices within the coverage area. Further, each terminal device may be associated with a respective further round trip time delay component that is specific to that terminal device, and the combination of the common round trip time delay component and the respective further round trip time delay component may indicate the corresponding round trip time delay specific to that terminal device. Illustratively, the processor may use the determined location of the terminal device to calculate the respective further round trip time delay. This approach may simplify the scheduling process and reduce the computational load on the processor. Additionally, it may ensure that the communication timing is synchronized across multiple devices, potentially improving overall network performance. Illustratively, the common round trip time delay component may be the smallest round trip time delay among the terminal devices within the coverage area.

The processor may use various methods to determine the location of the terminal device. Illustratively, the network access node may receive location of the terminal device from the terminal device. In some examples, the processor may determine the location of the terminal device based on a determined doppler shift for the terminal device. Illustratively, the processor may estimate the position of the terminal device by analyzing the frequency shift that occurs due to the relative motion between the terminal device and the network access node. The doppler shift may provide information about the velocity and direction of the terminal device, which may be used to enhance the accuracy of the location determination. This method may be particularly useful in scenarios where global positioning system signals are weak or unavailable, such as in indoor environments or urban canyons. This feature may also support applications that require precise location tracking, such as asset tracking, navigation, and location-based services. The processor may utilize algorithms to process the doppler shift data and correlate it with known reference points or signal characteristics to estimate the terminal device's location.

In an example, the processor may further estimate the respective further round trip time delay based on a received physical random access channel transmission from the terminal device; encode a random access message for a transmission of a random access response in response to the received physical random access channel transmission. In this configuration, a timing advance (TA) value in the random access response (RAR) may be based on the round trip time delay for more accurate synchronization between the network access node and the terminal device.

Although some of the aspects may be described in a manner that the processor performs described operations for a terminal device, the processor may perform these operations for each terminal device within its coverage area. Illustratively, the processor may schedule at least one other terminal device within the coverage area based on the common round trip time delay component.

In accordance with various aspects described herein, the network access node (e.g. satellite network access node) may perform terminal device positioning using designated reference transmissions. One method to determine the initial location of a user equipment may include utilizing physical random access channel transmissions. The user equipment may transmit a physical random access channel preamble, which is received by the satellite network access node (e.g. satellite next generation node B (satellite gNB)). Based on the received physical random access channel signal, the satellite network access node can estimate the distance to the user equipment relative to its own location and thus determine a location, which may be an approximate location. Once the initial position is determined, the satellite-based network access node can continue to track the location of the user equipment using demodulation reference signals (DMRS). Demodulation reference signals are embedded within uplink transmissions and may allow for continuous tracking of the user equipment's position by measuring changes in signal timing and frequency, which may result from the relative motion between the satellite and the user equipment. Accordingly, an efficient way may be provided to maintain accurate positioning of user equipments in non-terrestrial networks without relying on global navigation satellite system data.

In an example, the processor may estimate an round trip time delay and a doppler shift associated with the physical random access channel preamble to determine the location of the terminal device. This may include analyzing the time it takes for a signal to travel from the terminal device to the network access node, as well as the frequency shift that occurs due to the relative motion between the terminal device and the network access node. By analyzing the round trip time delay and the doppler shift, the processor may determine the location of the terminal device. This additional step may enhance the precision of the location tracking, which may be particularly useful in environments where signal reflections or multipath effects are prevalent. The estimation of round trip time delay and doppler shift may also help in mitigating errors caused by such effects.

In an example, illustratively in which the network access node does not have information about which user equipment is sending the physical random access channel preamble and/or which physical random access channel preamble is sent, the processor may perform a hypothesis testing on the physical random access channel preamble using a plurality of doppler shift hypotheses. Each doppler shift hypothesis may be associated with a respective shift of received frequency symbols at a physical random access channel resource. The processor may further estimate a respective frequency domain channel for the respective shift of received frequency symbols; and select one of the doppler shift hypotheses based on the respective frequency domain channel for each doppler hypothesis. In some examples, the processor may perform this for all possible physical random access channel preambles. This approach may further enhance the accuracy of uplink transmission configuration by ensuring that the frequency domain channel estimation is based on the most appropriate doppler shift hypothesis.

In such a scenario, the processor may convert the respective frequency domain channel to a corresponding time domain channel, which may facilitate the identification of a peak in the corresponding time domain channel. The processor may use the identified peak to determine the round trip time delay based on the location of the peak. The processor may perform the peak identification via any techniques including amplitude comparison. For example, the processor may further determine the doppler shift by selecting the doppler shift hypothesis having the highest peak or by calculating a linear combination of doppler shift hypotheses generating the peaks.

In an example, the processor may estimate time offsets and frequency offsets from the received demodulation reference signals to track the location of the terminal device. The processor may analyze the timing and frequency characteristics of the demodulation reference signal to determine any deviations from expected values. The processor may then determine changes in the estimated time offsets and frequency offsets over time. These changes may indicate movement or other variations in the terminal device's behavior or environment. Based on these changes, the processor may update the location of the terminal device, which may allow for accurate and dynamic tracking of the terminal device's location. Alternative implementations may include different algorithms for estimating and updating offsets, or the use of additional signals or data sources to enhance accuracy.

In accordance with various aspects described herein, the processor may use aspects associated with scheduling of a terminal device and/or positioning of a terminal device to mitigate doppler shift and/or sampling drift associated with the transmissions between the terminal device and the network access node. Furthermore, the network access node referred to herein may be the network access node that is part of an non-terrestrial network in a cellular communication context. This setup may also enable the processor to support various communication protocols and standards commonly used in satellite communications, such as those defined by the 3GPP for non-terrestrial network.

As used herein, a satellite may refer to a space-borne vehicle including a bent pipe (transparent or non-regenerative) payload or a regenerative payload telecommunication transmitter. The satellite may be placed into low-earth orbit (LEO) typically at an altitude between 500 km to 2000 km, medium-earth orbit (MEO) typically at an altitude between 8000 to 20000 km, geostationary-satellite earth orbit (GEO) at 35 786 km altitude, or highly elliptical orbit (HEO). The term satellite may further encompass an airborne vehicle embarking a bent pipe payload or a regenerative payload telecommunication transmitter, typically at an altitude between 8 to 50 km.

As used herein, a satellite access node may refer to a satellite that acts as a relay or intermediary between user equipments and the ground network. The satellite may have a transparent payload, such that it does not process or regenerate a received signal but simply forwards the received signal between the user equipment and the ground station. In cellular communication context, this may be a satellite with satellite functions as a relay node, forwarding signals to an non-terrestrial network gateway, which then connects to the core network. An example of this may be a low earth orbit satellite. It is to be noted that in this configuration, one way propagation delay may correspond to the sum of feeder link propagation delay and user link propagation delay (i.e. propagation delay between gateway and terminal device via the satellite). Round trip time delay may correspond to delay over the path gateway-satellite-user equipment-satellite-gateway, which corresponds to twice the one way propagation delay.

As used herein, a satellite-based network access node may refer to a satellite that performs more advanced functions than a satellite access node. The satellite-based network access node may have a regenerative payload, such that it can process, demodulate, and regenerate signals before forwarding them to the core network or user equipment. A satellite-based network access node may be considered as a stand-alone base station. It may perform base station-like functions such as managing radio resources, scheduling transmissions, and handling mobility management for user equipments. In cellular communication context, this may be a satellite functioning as a gNB (e.g. satellite gNB) in an non-terrestrial network architecture, providing direct access to user equipments without needing an intermediary terrestrial gateway. It is to be noted that in this configuration, one way propagation delay may correspond to the propagation delay between the satellite and the user equipment. Round trip time delay may correspond to delay over the path Satellite-user equipment-Satellite.

The apparatuses and methods described herein may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the following examples. Various exemplary radio communication technologies that the apparatuses and methods described herein may utilize include, but are not limited to: a Global System for Mobile Communications (“GSM”) radio communication technology, a General Packet Radio Service (“GPRS”) radio communication technology, an Enhanced Data Rates for GSM Evolution (“EDGE”) radio communication technology, and/or a Third Generation Partnership Project (“3GPP”) radio communication technology, for example Universal Mobile Telecommunications System (“UMTS”), Freedom of Multimedia Access (“FOMA”), 3GPP Long Term Evolution (“LTE”), 3GPP Long Term Evolution Advanced (“LTE Advanced”), Code division multiple access 2000 (“CDMA2000”), Cellular Digital Packet Data (“CDPD”), Mobitex, Third Generation (3G), Circuit Switched Data (“CSD”), High-Speed Circuit-Switched Data (“HSCSD”), Universal Mobile Telecommunications System (“Third Generation”) (“UMTS (3G)”), Wideband Code Division Multiple Access (Universal Mobile Telecommunications System) (“W-CDMA (UMTS)”), High Speed Packet Access (“HSPA”), High-Speed Downlink Packet Access (“HSDPA”), High-Speed Uplink Packet Access (“HSUPA”), High Speed Packet Access Plus (“HSPA+”), Universal Mobile Telecommunications System-Time-Division Duplex (“UMTS-time division duplex”), Time Division-Code Division Multiple Access (“TD-CDMA”), Time Division-Synchronous Code Division Multiple Access (“TD-CDMA”), 3rd Generation Partnership Project Release 8 (Pre-4th Generation) (“3GPP Rel. 8 (Pre-4G)”), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18 (3rd Generation Partnership Project Release 18), 3GPP 4G, 3GPP LTE Extra, LTE-Advanced Pro, LTE Licensed-Assisted Access (“LAA”), MuLTEfire, UMTS Terrestrial Radio Access (“UTRA”), Evolved UMTS Terrestrial Radio Access (“E-UTRA”), Long Term Evolution Advanced (4th Generation) (“LTE Advanced (4G)”), cdmaOne (“2G”), Code division multiple access 2000 (Third generation) (“CDMA2000 (3G)”), Evolution-Data Optimized or Evolution-Data Only (“EV-DO”), Advanced Mobile Phone System (1st Generation) (“AMPS (1G)”), Total Access Communication arrangement/Extended Total Access Communication arrangement (“TACS/ETACS”), Digital AMPS (2nd Generation) (“D-AMPS (2G)”), Push-to-talk (“PTT”), Mobile Telephone System (“MTS”), Improved Mobile Telephone System (“IMTS”), Advanced Mobile Telephone System (“AMTS”), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (“Autotel/PALM”), ARP (Finnish for Autoradiopuhelin, “car radio phone”), NMT (Nordic Mobile Telephony), High capacity version of NTT (Nippon Telegraph and Telephone) (“Hicap”), Cellular Digital Packet Data (“CDPD”), Mobitex, DataTAC, Integrated Digital Enhanced Network (“iDEN”), Personal Digital Cellular (“PDC”), Circuit Switched Data (“CSD”), Personal Handy-phone System (“PHS”), Wideband Integrated Digital Enhanced Network (“WiDEN”), iBurst, Unlicensed Mobile Access (“UMA”), also referred to as also referred to as 3GPP Generic Access Network, or GAN standard), Zigbee, Bluetooth®, Wireless Gigabit Alliance (“WiGig”) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p and other) Vehicle-to-Vehicle (“V2V”) and Vehicle-to-X (“V2X”) and Vehicle-to-Infrastructure (“V2I”) and Infrastructure-to-Vehicle (“I2V”) communication technologies, 3GPP cellular V2X, DSRC (Dedicated Short Range Communications) communication arrangements such as Intelligent-Transport-Systems, and other existing, developing, or future radio communication technologies.

The apparatuses and methods described herein may use such radio communication technologies according to various spectrum management schemes, including, but not limited to, dedicated licensed spectrum, unlicensed spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System in 3.55-3.7 GHz and further frequencies), and may use various spectrum bands including, but not limited to, IMT (International Mobile Telecommunications) spectrum (including 450-470 MHz, 690-960 MHz, 1710-2025 MHz, 2110-2200 MHz, 2300-2400 MHz, 2500-2690 MHz, 698-790 MHz, 610-790 MHz, 3400-3600 MHz, etc., where some bands may be limited to specific region(s) and/or countries), IMT-advanced spectrum, IMT-2020 spectrum (expected to include 3600-3800 MHz, 3.5 GHz bands, 600 MHz bands, bands within the 24.25-86 GHz range, etc.), spectrum made available under FCC's “Spectrum Frontier” 4G initiative (including 27.5-28.35 GHz, 29.1-29.25 GHz, 31-31.3 GHz, 37-38.6 GHz, 38.6-40 GHz, 42-42.5 GHz, 47-64 GHz, 64-71 GHz, 61-76 GHz, 81-86 GHz and 92-94 GHz, etc.), the ITS (Intelligent Transport Systems) band of 4.9 GHz (typically 4.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), the 60.2 GHz-71 GHz band, any band between 65.88 GHz and 61 GHz, bands currently allocated to automotive radar applications such as 66-81 GHz, and future bands including 94-300 GHz and above. Furthermore, the apparatuses and methods described herein can also employ radio communication technologies on a secondary basis on bands such as the TV White Space bands (typically below 690 MHz) where e.g. the 400 MHz and 600 MHz bands are prospective candidates. Besides cellular applications, specific applications for vertical markets may be addressed such as PMSE (Program Making and Special Events), medical, health, surgery, automotive, low-latency, drones, etc. applications. Furthermore, the apparatuses and methods described herein may also use radio communication technologies with a hierarchical application, such as by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc. The apparatuses and methods described herein can also use radio communication technologies with different Single Carrier or orthogonal frequency division multiplexing flavors (CP-orthogonal frequency division multiplexing, SC-FDMA, SC-orthogonal frequency division multiplexing, filter bank-based multicarrier (FBMC), OFDMA, etc.) and e.g. 3GPP NR (New Radio), which can include allocating the orthogonal frequency division multiplexing carrier data bit vectors to the corresponding symbol resources.

Radio communication technologies may be classified as one of a Short Range radio communication technology or Cellular Wide Area radio communication technology. Short Range radio communication technologies may include Bluetooth, WLAN (e.g., according to any IEEE 802.11 standard), and other similar radio communication technologies. Cellular Wide Area radio communication technologies may include Global System for Mobile Communications (“GSM”), Code Division Multiple Access 2000 (“CDMA2000”), Universal Mobile Telecommunications System (“UMTS”), Long Term Evolution (“LTE”), General Packet Radio Service (“GPRS”), Evolution-Data Optimized (“EV-DO”), Enhanced Data Rates for GSM Evolution (“EDGE”), High Speed Packet Access (HSPA; including High Speed Downlink Packet Access (“HSDPA”), High Speed Uplink Packet Access (“HSUPA”), HSDPA Plus (“HSDPA+”), and HSUPA Plus (“HSUPA+”)), Worldwide Interoperability for Microwave Access (“WiMax”) (e.g., according to an IEEE 802.16 radio communication standard, e.g., WiMax fixed or WiMax mobile), etc., and other similar radio communication technologies. Cellular Wide Area radio communication technologies also include “small cells” of such technologies, such as microcells, femtocells, and picocells. Cellular Wide Area radio communication technologies may be generally referred to herein as “cellular” communication technologies.

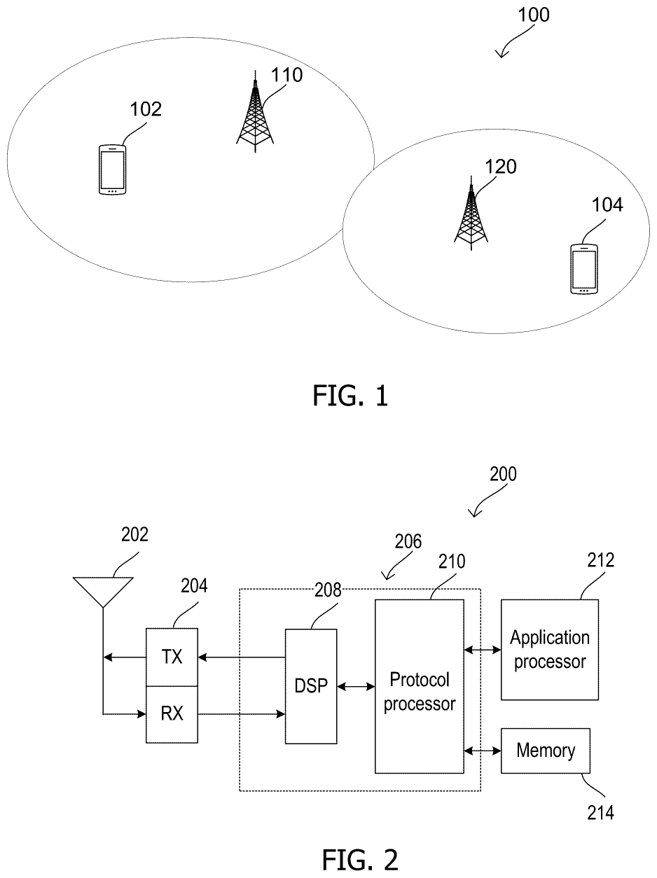

FIGS. 1 and 2 depict a general network and device architecture for wireless communications and/or sensing operations. In particular, FIG. 1 shows an exemplary radio communication network 100 according to some aspects, which may include terminal devices 102 and 104 and network access nodes 110 and 120 (e.g. radio access nodes). Radio communication network 100 may communicate with terminal devices 102 and 104 via network access nodes 110 and 120 over a radio access network. Each of terminal devices 102 and 104 or network access nodes 110 and 120 may be a sensing communication device as described herein that may perform a sensing operation. Although certain examples described herein may refer to a particular radio access network context (e.g., 6G, 5G NR, LTE, UMTS, GSM, other 3rd Generation Partnership Project (3GPP) networks, WLAN/WiFi, Bluetooth, mmWave, etc.), these examples are demonstrative and may therefore be readily applied to any other type or configuration of radio access network. The number of network access nodes and terminal devices in radio communication network 100 is exemplary and is scalable to any amount.

In an exemplary cellular context, network access nodes 110 and 120 may be base stations (e.g., eNodeBs, NodeBs, Base Transceiver Stations (BTSs), gNodeBs, or any other type of base station), while terminal devices 102 and 104 may be cellular terminal devices (e.g., Mobile Stations (MSs), User Equipments (user equipments), or any type of cellular terminal device). Network access nodes 110 and 120 may therefore interface (e.g., via backhaul interfaces) with a cellular core network such as an Evolved Packet Core (EPC, for LTE), Core Network (CN, for UMTS), or other cellular core networks, which may also be considered part of radio communication network 100. The cellular core network may interface with one or more external data networks.

Network access nodes 110 and 120 (and, optionally, other network access nodes of radio communication network 100 not explicitly shown in FIG. 1) may accordingly provide a radio access network to terminal devices 102 and 104 (and, optionally, other terminal devices of radio communication network 100 not explicitly shown in FIG. 1). In an exemplary cellular context, the radio access network provided by network access nodes 110 and 120 may enable terminal devices 102 and 104 to wirelessly access the core network via radio communications. The core network may provide switching, routing, and transmission, for traffic data related to terminal devices 102 and 104, and may further provide access to various internal data networks (e.g., control nodes, routing nodes that transfer information between other terminal devices on radio communication network 100, etc.) and external data networks (e.g., data networks providing voice, text, multimedia (audio, video, image), and other Internet and application data). Furthermore, terminal devices 102 and 104 and network access nodes 110 and 120 may perform a sensing operation, particularly radar sensing, in accordance with joint communication and sensing (JCAS) architecture. In an exemplary short-range context, the radio access network provided by network access nodes 110 and 120 may provide access to internal data networks (e.g., for transferring data between terminal devices connected to radio communication network 100) and external data networks (e.g., data networks providing voice, text, multimedia (audio, video, image), and other Internet and application data).

In accordance with various aspects described herein, network access nodes 110 and 120 and terminal devices 102 and 104 perform their respective sensing operations in a manner, such that each device may perform its respective sensing operation according to its respective sensing signal configuration. Accordingly, each of these devices may generate and transmit its respective sensing signals according to a respective configuration that may include at least one of frequency resources used to transmit sensing signals, the bandwidth of the sensing signals, transmit power of the sensing signals, and waveform shape of the sensing signals which the respective device may determine before generating and/or transmitting the sensing signals. In some examples, a central orchestrator (e.g. a sensing orchestrator) may determine a respective sensing signal configuration for each device and send information representing the respective sensing signal configuration to the respective device.

The radio access network and core network (if applicable, such as for a cellular context) of radio communication network 100 may be governed by communication protocols that can vary depending on the specifics of radio communication network 100. Such communication protocols may define the scheduling, formatting, and routing of both user and control data traffic through radio communication network 100, which includes the transmission and reception of such data through both the radio access and core network domains of radio communication network 100. Accordingly, terminal devices 102 and 104 and network access nodes 110 and 120 may follow the defined communication protocols to transmit and receive data over the radio access network domain of radio communication network 100, while the core network may follow the defined communication protocols to route data within and outside of the core network. Exemplary communication protocols include 6G, 5G NR, LTE, UMTS, GSM, WiMAX, Bluetooth, WiFi, mmWave, etc., any of which may be applicable to radio communication network 100.

In various aspects, network access nodes 110 and 120 may include one or more central units (CUs), one or more distributed units (DU), and one or more radio units (RUs) to communicate with terminal devices 102 and 104. In various examples, a radio unit may include a device configured to implement various processing functions for RF. In particular the RU may implement functions of a lower PHY. A DU may include a device configured to implement various processing functions, in particular including functions of a higher PHY, MAC, and RLC. The skilled person may realize that this is one example of a split of the network stack and DUs and RUs may have different split configurations. The RU may be linked to terminal devices 102 and 104 over a radio connection, and to the DU over a fronthaul interface. In various examples, the fronthaul interface may be according to a Common Public Radio Interface (CPRI) or an Enhanced Common Public Radio Interface (eCPRI) configured to communicate over a connection via fiber optic cables, but there are also other communication mediums that may handle the fronthaul communication. In any event, the RUs may be serving a plurality of terminal devices, and there may be limitations in terms of link capacity and bandwidth with respect to the communication between the RUs and a corresponding DU over the fronthaul. It may be desirable to address some of the fronthaul limitations.

FIG. 2 shows an exemplary internal configuration of a communication device (e.g. a sensing communication device) according to various aspects. The communication device may include various aspects of radio communication devices (e.g. network access nodes 110, 120) or various aspects of mobile radio communication devices (e.g. terminal device 102, 104) as well. The communication device 200 may include antenna system 202, radio frequency (RF) transceiver 204, baseband modem 206 (including digital signal processor 208 and protocol controller 210), application processor 212, and memory 214. Although not explicitly shown in FIG. 2, in some aspects communication device 200 may include one or more additional hardware and/or software components, such as processors/microprocessors, controllers/microcontrollers, other specialty or generic hardware/processors/circuits, peripheral device(s), memory, power supply, external device interface(s), subscriber identity module(s) (SIMs), user input/output devices (display(s), keypad(s), touchscreen(s), speaker(s), external button(s), camera(s), microphone(s), etc.), or other related components.

Communication device 200 may transmit and receive radio signals on one or more radio access networks. Baseband modem 206 may direct such communication functionality of communication device 200 according to the communication protocols associated with each radio access network, and may execute control over antenna system 202 and RF transceiver 204 to transmit and receive radio signals according to the formatting and scheduling parameters defined by each communication protocol. Although various practical designs may include separate communication components for each supported radio communication technology (e.g., a separate antenna, RF transceiver, digital signal processor, and controller), for purposes of conciseness the configuration of communication device 200 shown in FIG. 2 depicts only a single instance of such components.

Communication device 200 may transmit and receive wireless signals with antenna system 202. Antenna system 202 may be a single antenna or may include one or more antenna arrays that each include multiple antenna elements. For example, antenna system 202 may include an antenna array at the top of communication device 200 and a second antenna array at the bottom of communication device 200. In some aspects, antenna system 202 may additionally include analog antenna combination and/or beamforming circuitry. In the receive (RX) path, RF transceiver 204 may receive analog radio frequency signals from antenna system 202 and perform analog and digital RF front-end processing on the analog radio frequency signals to produce digital baseband samples (e.g., in-phase/quadrature (IQ) samples) to provide to baseband modem 206. RF transceiver 204 may include analog and digital reception components including amplifiers (e.g., low noise amplifiers (LNAs)), filters, RF demodulators (e.g., RF IQ demodulators)), and analog-to-digital converters (ADCs), which RF transceiver 204 may utilize to convert the received radio frequency signals to digital baseband samples. In the transmit (TX) path, RF transceiver 204 may receive digital baseband samples from baseband modem 206 and perform analog and digital RF front-end processing on the digital baseband samples to produce analog radio frequency signals to provide to antenna system 202 for wireless transmission. RF transceiver 204 may thus include analog and digital transmission components including amplifiers (e.g., power amplifiers (PAs), filters, RF modulators (e.g., RF IQ modulators), and digital-to-analog converters (DACs), which RF transceiver 204 may utilize to mix the digital baseband samples received from baseband modem 206 and produce the analog radio frequency signals for wireless transmission by antenna system 202. In some aspects baseband modem 206 may control the radio transmission and reception of RF transceiver 204, including specifying the transmit and receive radio frequencies for operation of RF transceiver 204.

In accordance with various aspects provided herein, the communication device 200 may perform sensing operations within the radio communication network 100. Illustratively, the baseband modem 206, (e.g. the digital signal processor 208) may be configured to perform sensing-related signal processing in addition to traditional communication processing. For example, the baseband modem 206 may be configured to implement techniques like radar waveform generation, matched filtering for target detection, parameter estimation (e.g., range, velocity, angle) of detected targets, and environmental mapping. In some examples, the baseband modem 206 (e.g. the digital signal processor 208) may use its hardware accelerators and parallel processing capabilities to efficiently handle the computationally intensive sensing algorithms alongside communication tasks.

Furthermore, the baseband modem 206 (e.g. the protocol controller 210) may be configured to coordinate and/or manage joint operation of communication and sensing functions. Illustratively, the baseband modem 206 may schedule sensing and communication operations, allocate resources (e.g., time/frequency resources, antenna beams) between the sensing operations and the communication operations, and manage interference between them. The baseband modem (e.g. the protocol controller 210) may further implement sensing control protocols and interfaces to enable coordination with other network entities for distributed sensing operations as described herein.

In some examples, the application processor 212 may be configured to act as a source and sink for sensing data, similar to its role for communication data. The application processor 212 may execute sensing applications that are configured to process and interpret the sensing data received from the baseband modem 206. Illustratively, the application processor 212 may perform at least one of object detection and tracking, environmental mapping, and/or situational awareness services using the sensing data. In some examples, the application processor 212 may interface with external sensors (e.g., cameras, lidars) to fuse data from multiple sensing modalities for enhanced perception capabilities.

Correspondingly, the RF transceiver 204 may further support the transmission and reception of sensing waveforms in addition to communication signals. Illustratively, the RF transceiver 204 may generate and transmit sensing signals (e.g., frequency-modulated continuous waveforms for radar), and may process the received sensing signals to extract target information. In some examples, the RF transceiver 204 can use the same analog and digital components (e.g., amplifiers, filters, modulators/demodulators, ADCs/DACs) for sensing operations and the communication operations, potentially with additional hardware accelerators for sensing-specific tasks. Illustratively, the antenna system 202 may also support both communication and sensing functions, in some examples with separate antenna arrays or shared arrays with beamforming capabilities. In accordance with various aspects, the antenna system 202 can form narrow beams for extended sensing range or wide beams for faster coverage, depending on the sensing requirements and resource constraints. Techniques like multiple input multiple output and beamforming can be employed to enhance the sensing performance and enable features like high-resolution target parameter estimation and interference mitigation.

As shown in FIG. 2, baseband modem 206 may include digital signal processor 208, which may perform physical layer (PHY, layer 1) transmission and reception processing to, in the transmit path, prepare outgoing transmit data provided by protocol controller 210 for transmission via RF transceiver 204, and, in the receive path, prepare incoming received data provided by RF transceiver 204 for processing by protocol controller 210. Digital signal processor 208 may be configured to perform one or more of error detection, forward error correction encoding/decoding, channel coding and interleaving, channel modulation/demodulation, physical channel mapping, radio measurement and search, frequency and time synchronization, antenna diversity processing, power control and weighting, rate matching/de-matching, retransmission processing, interference cancelation, and any other physical layer processing functions. Digital signal processor 208 may be structurally realized as hardware components (e.g., as one or more digitally-configured hardware circuits or field programmable gate array (FPGAs)), software-defined components (e.g., one or more processors configured to execute program code defining arithmetic, control, and I/O instructions (e.g., software and/or firmware) stored in a non-transitory computer-readable storage medium), or as a combination of hardware and software components. In some aspects, digital signal processor 208 may include one or more processors configured to retrieve and execute program code that defines control and processing logic for physical layer processing operations. In some aspects, digital signal processor 208 may execute processing functions with software via the execution of executable instructions. In some aspects, digital signal processor 208 may include one or more dedicated hardware circuits (e.g., application specific integrated circuits (ASICs), field programmable gate arrays, and other hardware) that are digitally configured to specific execute processing functions, where the one or more processors of digital signal processor 208 may offload certain processing tasks to these dedicated hardware circuits, which are known as hardware accelerators. Exemplary hardware accelerators can include fast fourier transform (FFT) circuits and encoder/decoder circuits. In some aspects, the processor and hardware accelerator components of digital signal processor 208 may be realized as a coupled integrated circuit.

Communication device 200 may be configured to operate according to one or more radio communication technologies. Digital signal processor 208 may be responsible for lower-layer processing functions (e.g., layer 1/PHY) of the radio communication technologies, while protocol controller 210 may be responsible for upper-layer protocol stack functions (e.g., data link layer/layer 2 and/or network layer/layer 3). Protocol controller 210 may thus be responsible for controlling the radio communication components of communication device 200 (antenna system 202, RF transceiver 204, and digital signal processor 208) in accordance with the communication protocols of each supported radio communication technology, and accordingly may represent the access stratum and non-access stratum (NAS) (also encompassing layer 2 and layer 3) of each supported radio communication technology. Protocol controller 210 may be structurally embodied as a protocol processor configured to execute protocol stack software (retrieved from a controller memory) and subsequently control the radio communication components of communication device 200 to transmit and receive communication signals in accordance with the corresponding protocol stack control logic defined in the protocol software. Protocol controller 210 may include one or more processors configured to retrieve and execute program code that defines the upper-layer protocol stack logic for one or more radio communication technologies, which can include data link layer/layer 2 and network layer/layer 3 functions. Protocol controller 210 may be configured to perform both user-plane and control-plane functions to facilitate the transfer of application layer data to and from radio communication device 200 according to the specific protocols of the supported radio communication technology. User-plane functions can include header compression and encapsulation, security, error checking and correction, channel multiplexing, scheduling and priority, while control-plane functions may include setup and maintenance of radio bearers. The program code retrieved and executed by protocol controller 210 may include executable instructions that define the logic of such functions.

Communication device 200 may also include application processor 212 and memory 214. Application processor 212 may be a central processing unit, and may be configured to handle the layers above the protocol stack, including the transport and application layers. Application processor 212 may be configured to execute various applications and/or programs of communication device 200 at an application layer of communication device 200, such as an operating system (OS), a user interface (UI) for supporting user interaction with communication device 200, and/or various user applications. The application processor may interface with baseband modem 206 and act as a source (in the transmit path) and a sink (in the receive path) for user data, such as voice data, audio/video/image data, messaging data, application data, basic internet/web access data, etc. In the transmit path, protocol controller 210 may therefore receive and process outgoing data provided by application processor 212 according to the layer-specific functions of the protocol stack, and provide the resulting data to digital signal processor 208. Digital signal processor 208 may then perform physical layer processing on the received data to produce digital baseband samples, which digital signal processor may provide to RF transceiver 204. RF transceiver 204 may then process the digital baseband samples to convert the digital baseband samples to analog RF signals, which RF transceiver 204 may wirelessly transmit via antenna system 202. In the receive path, RF transceiver 204 may receive analog RF signals from antenna system 202 and process the analog RF signals to obtain digital baseband samples. RF transceiver 204 may provide the digital baseband samples to digital signal processor 208, which may perform physical layer processing on the digital baseband samples. Digital signal processor 208 may then provide the resulting data to protocol controller 210, which may process the resulting data according to the layer-specific functions of the protocol stack and provide the resulting incoming data to application processor 212. Application processor 212 may then handle the incoming data at the application layer, which can include execution of one or more application programs with the data and/or presentation of the data to a user via a user interface.

Memory 214 may embody a memory component of communication device 200, such as a hard drive or another such permanent memory device. Although not explicitly depicted in FIG. 2, the various other components of communication device 200 shown in FIG. 2 may additionally each include integrated permanent and non-permanent memory components, such as for storing software program code, buffering data, etc.

In accordance with some radio communication networks, terminal devices 102 and 104 may execute mobility procedures to connect to, disconnect from, and switch between available network access nodes of the radio access network of radio communication network 100. As each network access node of radio communication network 100 may have a specific coverage area, terminal devices 102 and 104 may be configured to select and re-select \available network access nodes in order to maintain a strong radio access connection with the radio access network of radio communication network 100. For example, terminal device 102 may establish a radio access connection with network access node 110 while terminal device 104 may establish a radio access connection with network access node 112. In the event that the current radio access connection degrades, terminal devices 102 or 104 may seek a new radio access connection with another network access node of radio communication network 100; for example, terminal device 104 may move from the coverage area of network access node 112 into the coverage area of network access node 110. As a result, the radio access connection with network access node 112 may degrade, which terminal device 104 may detect via radio measurements such as signal strength or signal quality measurements of network access node 112. Depending on the mobility procedures defined in the appropriate network protocols for radio communication network 100, terminal device 104 may seek a new radio access connection (which may be, for example, triggered at terminal device 104 or by the radio access network), such as by performing radio measurements on neighboring network access nodes to determine whether any neighboring network access nodes can provide a suitable radio access connection. As terminal device 104 may have moved into the coverage area of network access node 110, terminal device 104 may identify network access node 110 (which may be selected by terminal device 104 or selected by the radio access network) and transfer to a new radio access connection with network access node 110. Such mobility procedures, including radio measurements, cell selection/reselection, and handover are established in the various network protocols and may be employed by terminal devices and the radio access network in order to maintain strong radio access connections between each terminal device and the radio access network across any number of different radio access network scenarios.

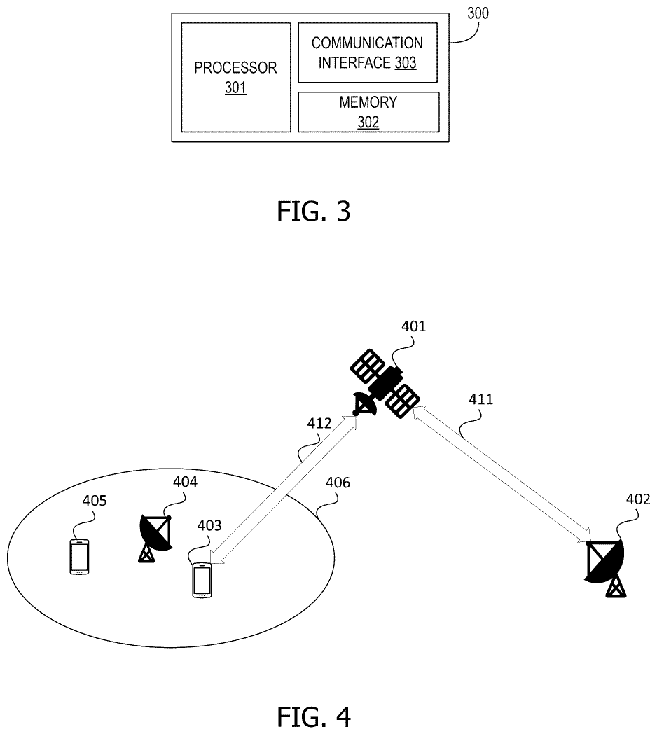

FIG. 3 shows an illustrative example of an apparatus in accordance with various aspects described herein. A communication device (e.g. the communication device 200) configured to operate as a network access node as described herein may include the apparatus 300, which may illustratively be a satellite-based network access node or a satellite access node. Illustratively, the communication device may be a network access node 110, 120, or a terminal device 102, 104.

The apparatus 300 may include a processor 301, a memory 302, and a communication interface 303 configured to receive and transmit communication signals in order to communicate with further entities within the radio access network. In some aspects, the communication interface 303 may include one or more signal paths to carry communication signals. The communication interface 303 may include one or more transceivers. In some examples, the communication interface 303 may further configured to transmit sensing signals and receive reflected sensing signals as described herein.

The processor 301 may include one or more processors, which may include a baseband processor and an application processor (e.g. application processor 212, baseband modem 206). In various examples, the processor 301 may include a central processing unit, a graphics processing unit, a hardware acceleration unit (e.g. one or more dedicated hardware accelerator circuits (e.g., application specific integrated circuits, field programmable gate arrays, and other hardware)), a neuromorphic chip, and/or a controller. The processor 301 may be implemented in one processing unit, e.g. a system on chip (SOC), or a processor. In accordance with various examples, the processor 301 may further provide further functions to process received communication signals. The memory 302 may store various types of information required for the processor 301, or the communication interface 303 to operate in accordance with various aspects described herein.

In some examples, while the communication device may provide communication and/or sensing services in its respective coverage area, the communication interface 303 may be configured to communicate with a plurality of further communication devices (e.g. further radio access nodes and/or user equipments), each configured to provide communication and/or sensing services in their respective coverage areas. For example, the apparatus 300 may receive information from each of the further communication devices via the communication interface 303, some of which are described herein. For example, the apparatus 300 may provide instructions to each of the further communication devices via the communication interface 303 as described herein. Illustratively, the communication interface 303 may include a transceiver (e.g. RF transceiver 204) configured to transmit or receive radio communication signals.

FIG. 4 shows an example of an illustrative diagram showing a satellite communication system with service and feeder links in accordance with various aspects described herein. The satellite communication system may illustratively include an non-terrestrial network. The system may include a network access node including the apparatus 300. The system may include a satellite 401 positioned in space. In some examples, the satellite 401 may act as the network access node, facilitating communication between ground-based devices and a ground station. In some examples, the ground station 402 may act as the network access node, facilitating communication with ground-based devices through the satellite 401. The ground station 402 may illustratively include an non-terrestrial network gateway. The satellite 401 may be a satellite access node and/or satellite-based network access node. The ground station 402 may relay data between the satellite 401 and the core network. The ground station 402 may communicate with the satellite 401 via a feeder link 411. A feeder link may refer to a radio link between the ground station 402 and the satellite 401.

The network access node, that may be the satellite 401 and/or the ground station 402, may provide a network access service to multiple terminal devices 403-405 with a coverage area 406 via respective service links connecting the satellite to terminal devices 403-405. In some examples, a relay station may be provided as a relay ground station and the network access service may be provided further via the relay ground station to the terminal devices 403-405. A service link 412 may facilitate two-way communication between a terminal device 403 and the satellite 401. Terminal devices 403-405 may include a user equipment 403, 405 and/or a very small aperture terminal 404 that may serve as an intermediary (i.e. relay ground station) for local user equipments. The satellite 401 may provide the network access service at different portions within the coverage area 406 using different beam patterns.

Noting that the processor 301 may be the processor of the satellite 401 or the ground station 402 as described herein, the processor 301 may manage multiple beams that cover different portions of the coverage area 406. The processor 301 may employ beamforming techniques to optimize resource distribution across the coverage area 406. For example, the processor 301 may allocate more resources to areas with higher traffic demand by adjusting beam patterns accordingly. Additionally, the processor 301 may implement frequency reuse techniques to enhance spectral efficiency and maximize throughput by allowing different beams to reuse frequencies without causing interference.

The processor 301 may manage communication between the satellite 401 or ground station 402 and terminal devices 403-405 via service links 412. The processor 301 may utilize radio resources by employing a scheduling algorithm that allocates time, frequency, and power resources among terminal devices 403-405 for communication. In some examples, the scheduling algorithm may receive information such as channel conditions, traffic demand, and quality of service (QoS) requirements for each terminal device. The processor 301 may be configured to perform any one of or both of transparent and regenerative architectures within the satellite communication system. In a transparent architecture, the processor 301 may operate with minimal signal processing, simply forwarding signals between terminal devices 403-405 and the ground station 402 without decoding or re-encoding them. In a regenerative architecture, the processor 301 may decode incoming signals, processes them onboard, and re-encodes them before forwarding them to their destination.

In a first aspect, the processor 301 may facilitate time division duplex communication by determining and managing the communication pattern between the network access node (e.g., satellite 401 or ground station 402) and terminal devices. The processor 301 may determine a time division duplex communication pattern, which may include a plurality of time slots allocated for uplink and/or downlink communication. The processor 301 may dynamically adjust the time division duplex communication pattern based on factors such as traffic demand, channel conditions, and quality of service requirements. For example, if there is higher demand for downlink data (e.g., streaming services), the processor 301 may allocate more time slots to downlink communication. Additionally, the processor 301 may manage the allocation of time slots for each terminal device, ensuring efficient use of radio resources. The processor 301 may accordingly schedule uplink and downlink transmissions to minimize interference and maximize throughput.

Once a time division duplex communication pattern is determined, which may include time slots for alternating uplink and downlink transmissions, the processor 301 may allocate specific time slots for the network access node to perform either uplink or downlink operations. For example, during downlink time slots, the processor 301 may instruct the network access node to transmit data to the terminal device via the service link. The communication interface 303 may facilitate the downlink transmission by modulating and sending the downlink communication signal from the network access node to the terminal device. Conversely, during uplink time slots, the processor 301 may schedule reception windows for incoming downlink communication signals from the terminal device. The communication interface 303 may receive these signals through the service link and demodulates them for further processing.

Additionally, the processor 301 may instruct the terminal device to align its transmission and reception schedules according to this time division duplex communication pattern. The processor 301 may enable the alignment of the terminal device's transmission and reception schedules according to the determined time division duplex communication pattern by scheduling the terminal device through sending specific instructions to the terminal device. Once the processor 301 has established the time division duplex communication pattern, which may include alternating time slots for uplink and downlink transmissions, the processor 301 may ensure that both the network access node and the terminal device are synchronized in their respective communication windows. In accordance various aspects described herein, the processor 301 may maintain the synchronization through scheduling time slots in which the scheduled device (e.g. one of the network access node or the terminal device) performs neither uplink nor downlink communication towards the other device (i.e. other one of the network access node or the terminal device). The processor 301 may further communicate these allocations to the terminal device via control signals transmitted over the service link. The processor 301 may encode information indicating the allocations (i.e. schedule) for transmission to the terminal device.

The processor 301 may allocate first time slots from the plurality of time slots in the time division duplex communication pattern for the network access node to perform either uplink or downlink communication with the terminal device. These first time slots are designated for active transmission or reception by the network access node with respect to the communication with the terminal device. Additionally, the processor 301 may allocate a number of second time slots, during which the network access node is scheduled to perform neither uplink nor downlink communication with the terminal device. The number of second time slots may be based on the round trip time delay, which accounts for the propagation delay between the network access node and the terminal device.

During these second time slots, while no active transmission or reception occurs at the network access node, the terminal device may still perform its respective communication tasks. For example, during the second time slots, a terminal device may receive previously transmitted downlink signals from the network access node or transmit uplink signals that will be received by the network access node in subsequent first time slots. This asymmetric allocation can ensure that signal propagation delays are accounted for, preventing overlap between transmission and reception windows.

The number of second time slots may vary depending on factors such as round trip time delay and traffic demand. In satellite communications with significant propagation delays, more second time slots may be allocated to account for these delays. This scheduling ensures proper synchronization between devices and minimizes interference caused by overlapping transmissions.

In some examples, during these second time slots, the processor 301 may dynamically adjust resource allocation based on real-time conditions such as traffic demand or channel quality. For instance, if a terminal device requires additional resources for uplink transmission due to high data demand, the processor may allocate additional second time slots for this purpose. Similarly, if downlink communication requires additional bandwidth, second time slots may be used to facilitate delayed reception at the terminal device. This flexibility allows efficient use of available resources while maintaining synchronization across multiple devices within the coverage area.

The processor 301 may further schedule the terminal device to perform neither uplink communication nor downlink communication (which may be referred to as being or operating “idle”) during at least one of the first time slots allocated for the network access node. It is to be emphasized that the described allocations of the time division duplex communication pattern (e.g. the first time slots, the second time slots) are specifically described as they are designated for the network access node to either transmit downlink signals to the terminal device or receive uplink signals from the terminal device. The processor 301 may schedule the terminal device to remain idle (i.e. perform neither uplink transmission nor downlink reception for the communication with the network access node) during at least one or some first time slots, so that no uplink or downlink communication occurs at the terminal device while the network access node is actively transmitting or receiving.

The number of first time slots during which the terminal device is scheduled to remain idle may be determined by the processor 301 based on factors such as round trip time delay. For example, in satellite communications with significant propagation delays, more first time slots may be allocated where the terminal device remains idle to account for these delays. In some examples, the number of such idle first time slots may be equal to the number of second time slots, which are similarly allocated based on round trip time delay. This may facilitate that both first and second time slots are appropriately balanced to maintain synchronization between uplink and downlink transmissions. In some examples, the processor 301 may calculate the number of second time slots by dividing the round trip time delay to a slot duration of the time division duplex communication pattern.

During these at least one first time slots where no uplink or downlink communication occurs at the terminal device, the network access node continues its communication tasks (e.g., transmitting downlink signals or receiving uplink signals). The processor 301 may dynamically adjust both first and second time slot allocations based on real-time factors such as traffic demand, channel quality, or quality of service requirements. For instance, if a terminal device requires additional resources for uplink transmission due to high data demand, the processor may adjust certain first time slots by reducing idle periods in favor of active communication. Similarly, if additional downlink bandwidth is required by another terminal device within the coverage area, adjustments can be made to optimize resource allocation without compromising synchronization.

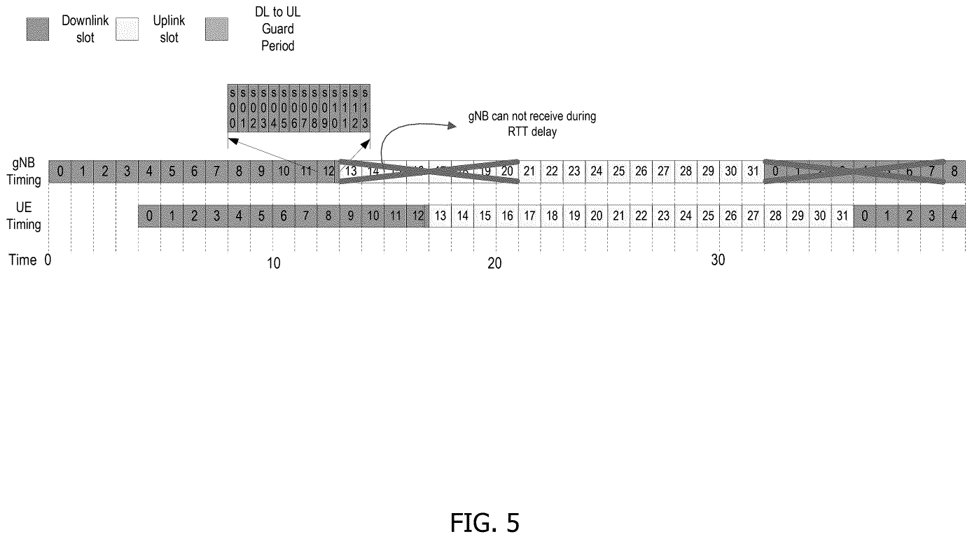

FIG. 5 shows an example of a timing diagram illustrating downlink and uplink communication slots of a time division duplex communication pattern for communication between the network access node (e.g. the gNB) and the terminal device (e.g. the user equipment). As illustrated herein, the diagram shows the timing relationship between the gNB timing and the user equipment timing, in relation to the round trip time delay. The gNB timing row shows the illustrated time division duplex communication pattern which includes 32 time slots (numbered from 0 to 31) in one time division duplex frame (i.e. time division duplex period), in which each time slot is allocated traditionally either for uplink or downlink (i.e. without idle slots). Time slots 0 to 12 are allocated as downlink slots and time slots 13 to 31 are allocated as uplink slots. Each time slot may include a first number of symbols (depicted as 14 symbols, s00 to s13) with a downlink to uplink guard period of a second number of symbols (depicted as 2 symbols, s12 and s13).

The user equipment timing row reflects the corresponding time slots at the user equipment side, which are shifted relative to the gNB timing due to the propagation delay between the user equipment and the gNB (e.g. the half of the round trip time delay). The diagram illustrates a propagation delay with a duration of 4 time slots. In other words, when the gNB performs downlink transmission for time slot 0 between 0^{th} time instance and 1^{st} time instance, the user equipment receives that downlink transmission (depicted time slot 0 in the user equipment timing row) between 4^{th} time instance and 5^{th} time instance.

This delay can prevent the gNB from receiving uplink signals during certain time slots immediately after downlink transmission, as indicated by the red crosses over specific time slots in the gNB timeline. In other words, considering that there may be a single connection (i.e. link) between antenna structures of the gNB and the user equipment, the gNB cannot receive uplink signals between time slots 13 to 20, since during a portion of this time period (depicted as the duration between 13^{th} time instance and 17^{th} time instance), the user equipment would still receive downlink signals transmitted by the gNB and during another portion of this time period (depicted as the duration between 17^{th} time instance and the 21^{st} time instance), the user equipment would perform uplink transmissions, which would begin arriving at the gNB at starting from the 21^{st} time instance.

This may also be described as the following: In case the gNB and the user equipment depicted here use the same time division duplex slot format, the gNB cannot receive an uplink transmission while the user equipment is still receiving downlink transmission, and the gNB cannot send a downlink transmission while it is waiting for the user equipment's transmission to complete in certain durations. Consequently, those times must be idle, resulting in a spectrum efficiency of approximately (time division duplex period−2*round trip time)/time division duplex period. This leads to a significant reduction in spectrum efficiency. For example, with a time division duplex period of 10 ms and an round trip time of 4 ms, only 20% efficiency is achievable.

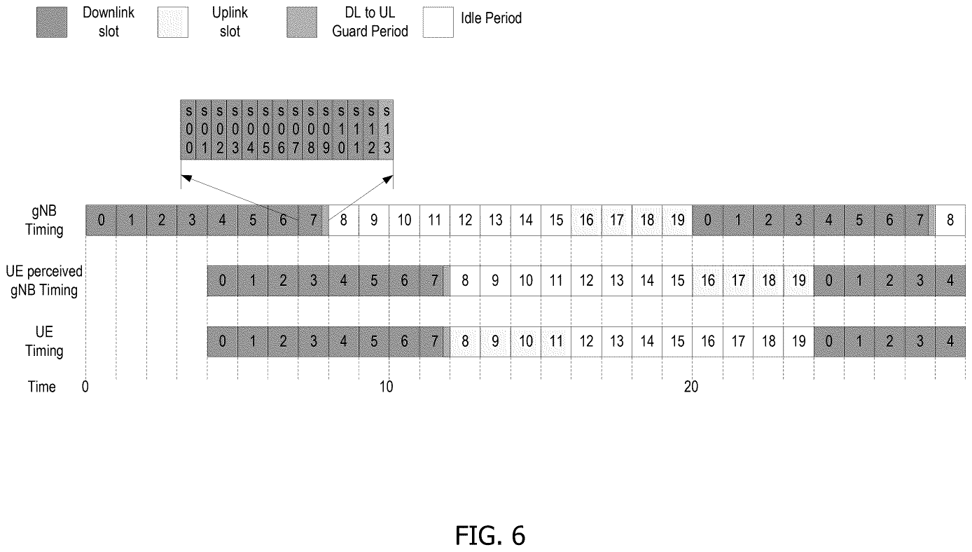

FIG. 6 illustrates an example of a timing diagram showing the downlink and uplink communication slots of a time division duplex communication pattern between a network access node (e.g., gNB) and a terminal device (e.g., user equipment) in accordance with various aspects described herein. The diagram highlights the timing relationship between the gNB timing and the user equipment timing, accounting for the round trip time delay inherent in satellite communications.

In this illustrative example, the gNB timing row shows the illustrated time division duplex communication pattern which includes 20 time slots (numbered from 0 to 19) in one time division duplex frame (i.e. time division duplex period), in which each time slot is allocated for one of uplink or downlink or idle. An idle period indicates that the gNB is scheduled to perform neither uplink nor downlink communication (i.e. neither uplink reception nor downlink transmission) with the user equipment using that connection. In this illustrative example, time slots 0 to 7 are allocated as downlink slots, time slots 8 to 15 are allocated as idle slots, and time slots 16 to 19 are allocated as uplink slots. Each time slot may include a first number of symbols (depicted as 14 symbols, s00 to s13) with a downlink to uplink guard period of a second number of symbols (depicted as 2 symbols, s12 and s13).

The user equipment perceived gNB timing row illustrates the corresponding time slots of the time division duplex communication pattern of the gNB at the user equipment side, which are shifted relative to the gNB timing due to the propagation delay between the user equipment and the gNB (e.g. the half of the round trip time delay). The diagram illustrates a propagation delay with a duration of 4 time slots. In other words, when the gNB performs downlink transmission for time slot 0 between 0^{th} time instance and 1^{st} time instance, the user equipment receives that downlink transmission (depicted time slot 0 in the user equipment timing row) between 4^{th} time instance and 5^{th} time instance.

Traditionally, the propagation delay would prevent the gNB from receiving uplink signals during certain time slots immediately after downlink transmission, as indicated by the red crosses over specific time slots in the gNB timeline. In other words, considering that there may be a single connection (i.e. link) between antenna structures of the gNB and the user equipment, the gNB would not be able to receive uplink signals during time slots 8 to 15. However, in this illustrative example, the processor 301 determines time slots 0 to 7 as downlink slots and time slots 16 to 19 as uplink slots as the first time slots described herein. The processor 301 further determines time slots 8 to 15 as the second time slots. As can be seen here, the number of the second time slots corresponds to 2 times of the propagation delay which is the round trip time delay in this example. It is to be noted that the processor 301 may also use timing advance commands for scheduling described herein for more granularity.

Furthermore, the processor 301 may also schedule the user equipment to communicate with the gNB as illustrated in the user equipment timing row. As illustrated herein, noting that the second time slots correspond to the duration defined between 8^{th} time instance and 16^{th} time instance, while the gNB becomes idle, the processor 301 may schedule the user equipment to perform uplink or downlink communication with the gNB. In this illustrative example, the processor 301 schedules the user equipment to perform downlink communications between 8^{th} time instance and 12^{th} time instance and to perform uplink communications between 12^{th} time instance and 16^{th} time instance. Also, the processor 301 further schedules the user equipment to perform neither uplink communication nor downlink communication with the gNB between 16^{th} time instance and 24^{th} time instance.

This may also be described as the following: The system spectrum efficiency can be improved by using asymmetric slot formats for the user equipment and the gNB. As illustrated herein, the user equipment's uplink slots are moved to immediately after downlink slots to enable early uplink transmission. As shown, there is no conflict between downlink transmission and uplink reception at the gNB. In the meantime, there is no conflict between downlink reception and uplink transmission at the user equipment. With such change, spectrum efficiency˜=(time division duplex period−round trip time)/time division duplex period. For example, when time division duplex period=10 ms and round trip time=4 ms, spectrum efficiency is improved to 60%.

As described herein, the processor 301 may allocate the first time slots, such that the first time slots include one or more consecutive downlink time slots (e.g. time slots 0 to 7) and one or more consecutive uplink time slots (e.g. time slots 16 to 19) within a time division duplex period. Furthermore, the processor 301 may allocate the second time slots such that they are provided (i.e. inserted) between these one or more consecutive uplink time slots and these one or more consecutive downlink time slots.

In some examples, in the constellation that the above-mentioned time division duplex communication pattern is of the network access node, the processor 301 may further generate a further time division duplex communication pattern of the terminal device and encode the further time division duplex communication pattern for a transmission to the terminal device to schedule the terminal device as described herein. The further time division duplex communication pattern may include one or more terminal device uplink time slots corresponding to the uplink time slots of the time division duplex communication pattern of the network access node. The further time division duplex communication pattern may further include one or more terminal device downlink time slots corresponding to the downlink time slots of the time division duplex communication pattern of the network access node. Similarly, the further time division duplex communication pattern may further include one or more terminal device idle time slots corresponding to the idle time slots of the time division duplex communication pattern of the network access node. In this illustrative example, the processor 301 configure the time division duplex communication pattern and the further time division duplex communication pattern to schedule the terminal device based on the round trip time delay as described herein. The processor 301 may configure both patterns based on the round trip time delay.

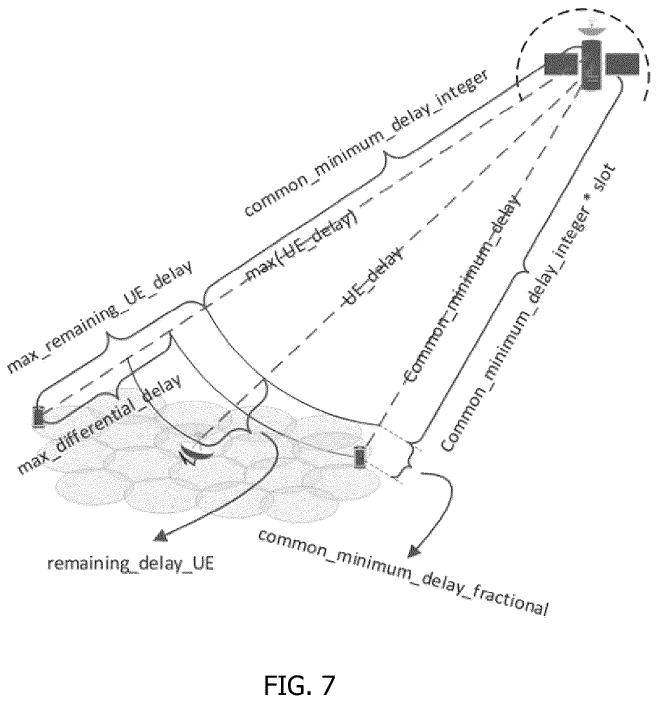

FIG. 7 shows an example illustrative representation of various delay parameters which a processor (e.g. the processor 301) may determine various parameters as described herein associated with the round trip time delay. The figure illustrates different representation of delays which the processor 301 may be consider for optimizing communication between the network access node and the terminal devices. The processor 301 may determine the round trip time delay based on a location of the terminal device. The processor 301 may determine the location of the terminal device in any known methods or methods described herein. In that sense, the figure illustrates the calculation of the round trip time delay for multiple terminal devices within the coverage area, and how this delay is accounted for when scheduling communication between the network access node and the terminal devices.

In some examples, the processor 301 may determine a common round trip time delay that is applicable to multiple terminal devices in the coverage area. This may simplify the delay management process by using a common delay value for these multiple terminal devices. Illustratively, the common round trip time delay is depicted as the common_minimum_delay in the illustration and the common round trip time delay may be the smallest round trip time delay among round trip time delays determined for the multiple terminal devices. The processor 301 may determine the common round trip time delay in the terms of slot duration. In that case, the common round trip time delay may be represented by a common_minimum_delay_integer, which represents the minimum integer number of time slots required to account for the smallest round trip time delay. Illustratively, the multiplication of the common_minimum_delay_integer and slot duration corresponds to the round trip time delay in time. For example, this common round trip time delay may be shared by the multiple terminal devices (e.g. all terminal devices within the coverage area), ensuring that no device experiences a delay shorter than this minimum value. In some examples, the processor 301 may use time-of-flight measurements or doppler shifts (or any other method) to calculate round trip time delays for each terminal device. Once these delays are determined, the processor 301 may select the smallest delay and configures it as the common round trip time delay for all devices in that coverage area. This can facilitate that all devices experience at least this minimum delay, allowing synchronized communication.

Furthermore, the processor 301 may also determine a respective further round trip time delay for each terminal device, which is added to the common round trip time delay to calculate the total round trip time delay for each device. This further round trip time delay may account for differences in location between terminal devices, as depicted by terms such as max_user equipment_delay, remaining_delay_user equipment, and max_remaining_user equipment_delay in the image. In other words, for a terminal device, the round trip time delay of that terminal device may be represented by the combination (e.g. sum) of the common round trip time delay and the respective further round trip time delay (e.g. the remaining_delay_user equipment or the max_remaining_user equipment_delay as depicted herein. These terms represent additional delays experienced by individual terminal devices based on their distance from the network access node. In some examples, the processor 301 may use location-based data such as global positioning system coordinates or signal strength measurements to estimate each terminal device's respective further round trip time delay. This further delay is then added to the common round trip time delay to calculate each terminal device's total round trip time. Additionally, or alternatively, the processor 301 may estimate further round trip time delays using techniques such as triangulation or doppler shift analysis based on signal propagation times or location data from global positioning system systems.

In some examples, the processor 301 may determine the location of the terminal device according to the round trip time delay determined for that terminal device. Furthermore, for each terminal device location, the combination of delay and doppler shift are unique. Therefore, by analyzing both delay and doppler shift, the processor 301 can determine the location of the terminal device in view of the location of the network access node. In some examples, the processor 301 may estimate the respective further round trip time delay (or the total round trip time delay of that terminal device) based on a received physical random access channel transmission from the terminal device. The processor 301 may then encode a random access message for transmission of a random access response, where the timing advance value in the random access response is based on the estimated round trip time delay.

Illustratively, the processor 301 may first receive a physical random access channel preamble transmitted by the terminal device, which is used by the terminal device to initiate communication with the network access node. Upon receiving this physical random access channel transmission, the processor 301 may begin estimating the round trip time delay, as described herein. In some examples, the processor 301 may monitor the service link for incoming physical random access channel preambles from terminal devices. Upon detecting a physical random access channel transmission, the processor 301 may record the time of arrival of the signal and begin calculating propagation delays. Once the physical random access channel transmission is received, the processor 301 may estimate the respective further round trip time delay for that terminal device. This further round trip time delay represents any additional propagation delay beyond a common round trip time delay shared by all devices in the coverage area. The processor 301 may estimate this further delay by analyzing the time difference between when the physical random access channel preamble was transmitted by the terminal device and when it was received at the network access node. Illustratively, the processor 301 may use signal propagation measurements (e.g., time-of-flight) to estimate how long it took for the physical random access channel signal to travel from the terminal device to the network access node. By comparing this time with known distances or propagation models, the processor can calculate an additional round trip time delay specific to that terminal device.

After estimating the further round trip time delay, the processor 301 may encode a random access message, which includes a random access response for transmission back to the terminal device. The random access response may include information such as timing synchronization parameters, including a timing advance value, which adjusts the timing of future transmissions from the terminal device to account for propagation delays. The processor 301 may encode an random access response message that includes a timing advance value calculated based on both the common round trip time delay and the respective further round trip time delay for that specific terminal device. The timing advance value in the random access response may be directly based on both components of round trip time delay the common round trip time delay shared by all devices and the respective further round trip time delay specific to each terminal device. By adjusting transmission timing using this timing advance value, future uplink signals from each terminal device can arrive at the network access node in sync with other devices.

In a second aspect, the processor 301 may determine and track location of one or more terminal devices within the coverage area. In accordance with various aspects described herein, the processor 301 may determine and track the location based on various types of reference signals which are known by both the terminal device and the processor 301 at an extent. Although this second aspect may be particularly employed for terminal devices without any global positioning system/global navigation satellite system-like positioning systems, this second aspect may further be used to improve and/or track starting from a determined location, which the processor 301 may also use a known position of the terminal device within the coverage area. Also, although aspects may have been described herein for a single terminal device, the apparatus 300 and the processor 301 may perform operations described herein to determine and track location of some or all terminal devices within the coverage area. It is further to be noted that although the first aspect and the second aspect, each including further more detailed aspects, have been described herein in relation to a single terminal device, the apparatus 300 and processor 301 may perform operations described herein with respect to the first aspect associated with the time division duplex communication pattern and the second aspect associated with the location determination separately or simultaneously.

In some examples, the processor 301 may determine the location of the terminal device based on the round trip time delay determined for that terminal device. The round trip time delay may represent the time it takes for signals to travel between the terminal device and the network access node (e.g., satellite or gNB). Additionally, for each terminal device, the combination of round trip time delay and doppler shift is unique, as both parameters are influenced by the relative position and motion of the terminal device with respect to the network access node. By analyzing both the round trip time delay and doppler shift, the processor 301 may estimate the location of the terminal device within the coverage area with a certain accuracy. For example, as depicted in FIG. 7, various delay parameters such as common_minimum_delay_integer and remaining_delay_user equipment are used to calculate the round trip time delay. The processor 301 may further refine this location estimate by analyzing doppler shift data, which may provide insight into the velocity and direction of movement of the terminal device relative to the network access node. This combination of round trip time delay and doppler shift may allow for precise location determination even in non-terrestrial networks where global positioning system/global navigation satellite system data may not be available.

In some aspects, using certain signaling schemes that are already present and widely used in communication technologies, such as physical random access channel preamble and demodulation reference signals in cellular communication, may be desirable for determining the location of terminal devices. These signals are known to both the terminal device and the network access node and can be leveraged for location estimation without requiring additional signaling overhead. For instance, the physical random access channel preamble may typically be used for initial access procedures, but it can also provide valuable timing information that may allow the processor 301 to estimate the round trip time delay between the terminal device and the network access node. Similarly, demodulation reference signal, which are embedded within uplink transmissions for channel estimation, can be used to track the relative motion of a terminal device by analyzing doppler shifts. By combining these existing signaling schemes with round trip time delay measurements, the processor 301 may determine and track the location of terminal devices within a coverage area of the network access node.

Once the location (e.g. an initial location) of the terminal device is determined, the processor 301 may configure uplink transmissions of the terminal device based on the location. In some examples, the processor 301 may configure the uplink transmissions to facilitate that uplink communication signals from the terminal device arrive at the network access node at appropriate times in which the communication interface 303 is configured to receive uplink transmissions. This configuration may include adjusting parameters such as timing advance to compensate for propagation delays caused by the distance between the terminal device and the network access node.

The processor 301 may, in response to the received physical random access channel transmission, encode a random access response message for a transmission to the terminal device, which may include the configuration associated with timing adjustments (e.g. a timing advance value) based on the location of the terminal device. In accordance with various aspects described herein, the processor 301 may further analyze demodulation reference signal received via uplink transmissions from the terminal device. The processor 301 may monitor changes associated with the uplink communication signals received from the terminal device, such as doppler shifts or variations in round trip time delay, and may continuously track how the location of the terminal device evolves over time.

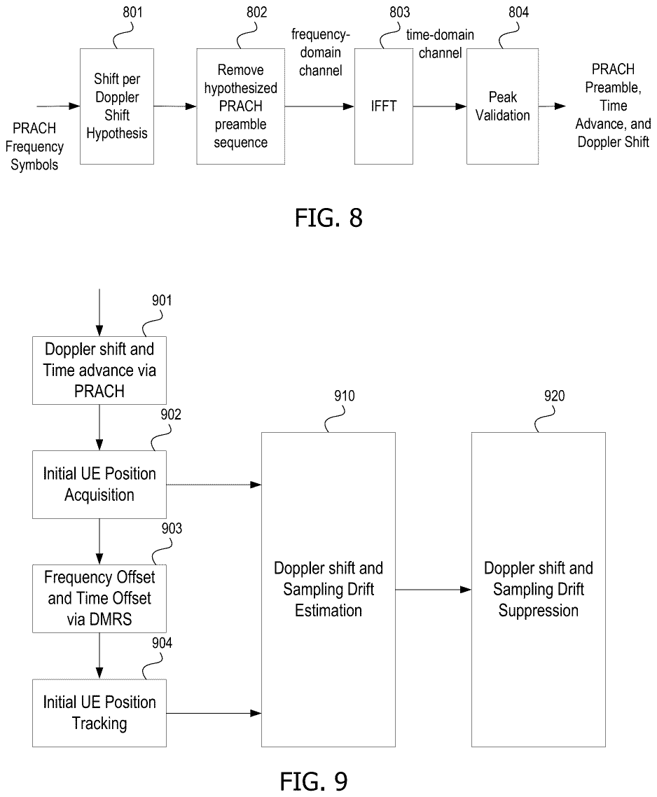

FIG. 8 shows an example of a block diagram to determine the round trip time delay and the doppler shift of the terminal device via hypothetical testing using a received physical random access channel signal including a physical random access channel preamble encoded by the terminal device. For each doppler shift hypothesis of multiple hypotheses, the processor 301 may perform blocks 801, 802, 803, and 804 described herein. The processor 301 may determine the round trip time delay and doppler shift of the terminal device via hypothesis testing as described herein. In 801, the processor 301 may obtain frequency symbols received within the physical random access channel resources. The processor 301 may linearly shift the received frequency domain symbols with a respective amount for each doppler shift hypothesis, wherein the amount of a respective shift for each doppler shift hypothesis is an integer number of physical random access channel subcarrier spacing. The number of doppler shift hypotheses and respective shift amounts can be designated based on a use case.

In block 802, the processor 301 may remove a hypothesized physical random access channel preamble sequence from the corresponding shifted frequency domain symbols of the respective doppler shift hypothesis. The hypothesized physical random access channel preamble may be a predetermined physical random access channel preamble for the corresponding physical random access channel resource. In some examples, the processor 301 may perform the block 802 for multiple hypothesized physical random access channel preambles that the terminal device can send. The processor 301 may estimate the frequency-domain channel by multiplying the shifted frequency-domain symbols with the conjugation of the transmit sequence symbol of the hypothesized physical random access channel preamble at each subcarrier.

The multiplication may allow the processor 801 to estimate how well each doppler shift hypothesis fits the received physical random access channel signal in view of the hypothesized physical random access channel preamble that is assumed to be transmitted by the terminal device. Correspondingly, the processor 301 may determine which doppler shift hypothesis best matches the actual conditions experienced by the terminal device.

In 803, the processor 301 may obtain the time-domain channel is obtained through inverse fast fourier transform (IFFT) operation on the estimated frequency-domain channel. In 804, the processor 301 may validate the peak of the time-domain channel by comparing its amplitude with a threshold. When a peak is validated, a physical random access channel preamble may be detected. The processor 301 may use the location of the peak to derive the timing advance. Furthermore, the processor may determine the actual doppler shift as either the doppler shift hypothesis that generates the highest valid peak or a linear combination of the doppler shift hypotheses that generates the valid peaks.

Illustratively, when the terminal device transmits a physical random access channel preamble while moving relative to the network access node, due to this motion, there will be both an round trip time delay and a doppler shift affecting the received signal. In 801, the processor 301 may apply various doppler shift hypotheses to account for different possible velocities of the terminal device. In 802, the processor 301 may then remove each hypothesized physical random access channel preamble sequence from these shifted signals and estimates a frequency-domain channel for each hypothesis. By comparing these estimated channels, in 804, the processor 301 can validate which hypothesis best matches reality, allowing processor 301 to accurately estimate both round trip time delay and timing advance and doppler shift (for velocity estimation).

In accordance with various aspects described herein, the processor 301 may identify a received physical random access channel transmission and decode the received physical random access channel transmission to identify a physical random access channel signal at the physical random access channel resource. In some examples, the processor 301 may perform hypothesis testing on a physical random access channel preamble received from a terminal device by using a plurality of doppler shift hypotheses. Each doppler shift hypothesis may be associated with a respective shift in the frequency of the received symbols of the physical random access channel signal at the physical random access channel resource.

For each doppler shift hypothesis, the processor 301 may estimate a respective frequency domain channel for that doppler shift hypothesis by analyzing how the received frequency symbols are affected by different doppler shifts. By comparing the estimated frequency domain channels, the processor 301 can select the doppler shift hypothesis that best matches the actual conditions experienced by the terminal device. For example, when the terminal device transmits a physical random access channel preamble, the signal may experience different levels of doppler shift depending on the relative velocity between the terminal device and the network access node. The processor 301 may generate multiple hypotheses, each corresponding to a different doppler shift value.

For each hypothesis, the processor 301 may estimate how the received frequency symbols would appear in the frequency domain under that particular doppler shift. The processor 301 may then compare these estimated channels for different doppler shift hypotheses to determine which hypothesis provides the best match. Correspondingly, the processor 301 may select one of the doppler shift hypothesis based on the respective frequency domain channel estimate for each doppler shift hypothesis. Once the most accurate doppler shift hypothesis is selected, processor 301 may refine its estimation of other key parameters, such as the round trip time delay and the timing advance, so that future uplink transmissions from the terminal device are synchronized with other devices in the coverage area.

In some examples, the processor 301 may convert the respective frequency domain channel to a corresponding time domain channel, for example by using inverse fast fourier transformer to obtain a corresponding time domain signal. Once in the time domain, the processor 301 may analyze the time domain signal to identify a peak in the time domain channel. The location of this peak in the time domain may correspond to the timing of the received physical random access channel signal, which the processor 301 may use to determine the round trip time delay.

For example, as shown in 803 of the first attached image, after applying a doppler shift hypothesis and removing the hypothesized physical random access channel preamble sequence, the processor 301 may perform an inverse fast fourier transform operation on the estimated frequency-domain channel. This may result in a time-domain channel where peaks represent strong signal reflections or direct paths between the terminal device and the network access node. In 804, the processor 301 may identify these peaks by comparing their amplitude with a predefined threshold. Once a peak is validated, the processor 301 may use the location of that peak within the time-domain channel to derive the round trip time delay. Illustratively, the processor 301 may determine the round trip time delay by measuring how far this peak is shifted from an expected reference point in time. For instance, if the peak occurs later than expected, the processor 301 determines that there is a longer propagation delay due to increased distance between the terminal device and the network access node. By determining the round trip time delay, processor 301 may adjust timing parameters such as timing advance to synchronize future uplink transmissions from the terminal device based on the round trip time delay.

The processor 301 may determine the doppler shift by selecting the doppler shift hypothesis that generates the highest peak in the time-domain channel. In some examples, the processor 301 may select the doppler shift hypothesis that results in the highest validated peak (i.e., the peak with the largest amplitude) as the actual doppler shift experienced by the terminal device. By selecting the hypothesis with the highest peak, processor 301 may use that peak for further processing, such as location determination or timing advance adjustment. In some examples, the processor 301 may calculate a linear combination of doppler shift hypotheses that generate peaks above a certain threshold. This approach may become useful when multiple hypotheses produce valid peaks in the time-domain channel, indicating that more than one doppler shift hypothesis may be contributing to the observed signal characteristics. The processor 301 may compare amplitudes of identified peaks in the doppler shift hypotheses against a predefined threshold. If multiple doppler shift hypotheses generate peaks above this threshold, instead of selecting just one hypothesis, the processor 301 may calculate a weighted linear combination of these hypotheses. In some examples, the weights may be proportional to the amplitude of each peak.

The processor 301 may configure uplink transmissions of the terminal device. In some examples, the processor 301 may configure the uplink frequency, on which the terminal device transmits the designated frequency band allocated for uplink communication. Additionally, the processor 301 may configure the transmission power of the terminal device to ensure that the uplink signal is strong enough to be reliably received by the network access node while minimizing interference with other devices. In some examples, the uplink transmission configuration may include scheduling the terminal device as described herein based on the time division duplex communication pattern of the network access node. Furthermore, the processor 301 may determine the modulation and coding scheme (MCS) to be used for uplink transmissions based on factors such as channel quality and traffic demand.

In accordance with various aspects described herein, the processor 301 may obtain the round trip time delay and the timing advance. The processor 301 may configure the uplink transmissions further based on the round trip time delay and the timing advance. For example, once both round trip time delay and doppler shift are estimated, the processor 301 may configure uplink transmissions for the terminal device by adjusting the timing advance, which may ensure that future uplink transmissions from the terminal device arrive at the network access node at precisely synchronized intervals. The uplink configuration may include sending a random access response message as described herein. In addition to configuring initial uplink transmissions, the processor 301 may continue to track changes in the terminal device's location and velocity over time by analyzing demodulation reference signal embedded within subsequent uplink transmissions. In some examples, the processor 301 may configure and schedule how and when these demodulation reference signal will be provided by the terminal device.

The network access node may perform various operations in managing communication with the terminal device by obtaining and processing demodulation reference signal transmitted by the terminal device. Demodulation reference signal are essential for channel estimation, which may allow the processor 301 to accurately demodulate uplink signals and track the terminal device's location and movement. The network access node may receive demodulation reference signal embedded within uplink transmissions from the terminal device and the processor 301 may decode signals received from the terminal device to obtain the demodulation reference signal of the terminal device. The processor 301 may process the demodulation reference signal to estimate the uplink channel conditions, such as signal strength, phase, and timing. By analyzing the demodulation reference signal, the processor 301 may correct any distortions caused by noise, interference, or doppler shifts due to the movement of the terminal device.

In dynamic environments, such as non-terrestrial networks, terminal devices may experience significant doppler shifts due to their relative motion with respect to the network access node. The processor 301 may use the demodulation reference signal to estimate these doppler shifts by comparing the received frequency-domain symbols with known reference symbols. This estimation may allow the processor 301 to adjust timing and frequency parameters as described herein. By processing demodulation reference signal, the processor 301 can continuously track changes in channel conditions, which may enable the processor 301 to dynamically adjust resource allocations for uplink transmissions. In some examples, the processor 301 may use this information to refine its estimation of the round trip time delay.

In some aspects, the processor 301 may estimate time offsets and/or frequency offsets from the received demodulation reference signal from the terminal device. The processor 301 may receive the demodulation reference signal from the terminal device. Upon receiving the demodulation reference signal, the processor 301 may analyze the demodulation reference signal to estimate both time offsets and frequency offsets. Illustratively, the processor 301 may perform channel estimation based on the received demodulation reference signal. For example, the processor 301 may multiply the received demodulation reference signal symbols with the conjugate of the transmitted demodulation reference signal sequence to estimate the frequency-domain channel. This operation may allow the processor 301 to determine how the signal has been affected by the transmission medium. Once the frequency-domain channel is estimated, the processor 301 may estimate time offsets by performing a conjugate multiplication between channels on two different subcarriers within the same orthogonal frequency division multiplexing symbol. This operation may help identify any timing misalignment between the terminal device and the network access node, which could be caused by propagation delays or movement of the terminal device. Furthermore, the processor 301 may perform a conjugate multiplication between channels on the same subcarrier across two different orthogonal frequency division multiplexing symbols, which may allow the processor 301 to detect any frequency shifts that may have occurred due to doppler effects, which are common in scenarios where there is relative motion between the terminal device and a satellite-based network access node.

By analyzing both time offsets and frequency offsets from these operations, the processor 301 may track changes in signal timing and frequency caused by movement of the terminal device. In some examples, the processor 301 may use this information to adjust uplink transmission parameters, such as timing advance or frequency correction. In a summary, starting from receiving demodulation reference signal from the terminal device, the processor 301 may perform channel estimation using demodulation reference signal symbols, estimate time offsets by comparing different subcarriers within an orthogonal frequency division multiplexing symbol, and estimate frequency offsets by comparing subcarriers across different orthogonal frequency division multiplexing symbols.

Accordingly, it may be considered that the time offset may indicate how much adjustment is needed to synchronize uplink transmissions from the terminal device with other devices in the coverage area. Furthermore, the frequency offset may indicate how much correction is needed to align uplink transmissions with the expected frequency. Once both time offsets and frequency offsets are estimated, the processor 301 may compare these values with previous estimates to determine any changes over time, which may provide insights into how fast and in what direction the terminal device is moving relative to the network access node. By continuously monitoring these changes, the processor 301 may update its previous estimate of the location of the terminal device.

In some examples, the processor 301 may estimate a frequency offset from a received demodulation reference signal by performing conjugate multiplication between the channel estimates of the same subcarrier across two different orthogonal frequency division multiplexing symbols. When the terminal device transmits demodulation reference signal as part of its uplink transmission, the processor 301 may receive these signals and estimate the channel conditions. To estimate the frequency offset, the processor 301 may compare how the channel has changed between two consecutive orthogonal frequency division multiplexing symbols on the same subcarrier, which may be achieved by performing conjugate multiplication between the channel estimates derived from each orthogonal frequency division multiplexing symbol. The processor 301 may determine how much the frequency has shifted based on the result of this multiplication, which may typically be caused by doppler effects due to relative motion between the terminal device and the network access node.

In some examples, the processor 301 may estimate a time offset from the respective received demodulation reference signal by performing conjugate multiplication between channels on two different subcarriers within the same orthogonal frequency division multiplexing symbol. This operation may allow the processor 301 to detect any timing misalignment between the terminal device and network access node that may have arisen due to propagation delays or movement of the terminal device. By comparing how different subcarriers behave within a single orthogonal frequency division multiplexing symbol, the processor 301 may determine if there is any time offset that needs to be corrected. For example, after estimating frequency offsets as described above, the processor 301 may also perform conjugate multiplication between different subcarriers within an orthogonal frequency division multiplexing symbol to estimate time offsets as described herein.

In the context of tracking the location of the terminal device, processor 301 may operate by continuously monitoring and analyzing various signal characteristics, such as round trip time delay, doppler shift, and demodulation reference signal. Tracking the location may correspond that processor 301 is not only determining the initial position of the terminal device but also updating this position over time as the terminal device and/or the network access node move relative to each other. The processor 301 may achieve the tracking by comparing changes in signal timing, frequency shifts, and other propagation metrics between consecutive transmissions from the terminal device. By analyzing these changes, the processor 301 may estimate how far and in what direction the terminal device has moved relative to the network access node.

For example, the processor 301 may determine at least one further location of the terminal device for tracking its movement over time that is different from the initial location determined according the physical random access channel preamble. After the initial location of the terminal device is determined using methods such as analyzing the physical random access channel preamble and estimating round trip time delay and doppler shift, the processor 301 may continue to monitor and update the location of the terminal device, which may involve continuously receiving and processing signals from the terminal device, such as demodulation reference signal embedded in uplink transmissions. By analyzing changes in signal characteristics over time, such as variations in doppler shift or timing offsets, the processor 301 can estimate how the terminal device's position evolves.

Once the processor 301 has determined at least one further location of the terminal device, the processor 301 may calculate both a signal doppler shift and a sampling drift associated with signal transmission between the network access node and the terminal device. The processor 301 may calculate the doppler shift by analyzing changes in frequency observed in consecutive uplink transmissions from the terminal device. In some examples, the processor 301 may implement the hypothesis testing to account for different possible doppler shifts, and to select or combine hypotheses that generate valid peaks. Correspondingly, the processor 301 may estimate a doppler shift value.

The processor 301 may further determine sampling drift. The processor may determine the sampling drift by analyzing how much variation occurs in signal timing between consecutive transmissions, which can be caused by clock inaccuracies at either the network access node or terminal device, or by changes in distance due to movement of the terminal device. By comparing timing information across multiple signals (e.g., demodulation reference signal or physical random access channel preambles), the processor 301 may estimate how much drift has occurred and adjust uplink transmission parameters accordingly.

In some examples, the processor 301 may determine the last obtained location of the terminal device as the at least one further location. The processor 301 may derive this last obtained location from previously tracked positions using methods such as analyzing physical random access channel preambles, demodulation reference signal, and calculating round trip time delay and doppler shift. Once this location is determined, the processor 301 may use the last obtained location to encode or decode communication signals based on the calculated signal doppler shift and sampling drift. For example, when a terminal device transmits an uplink signal, the processor 301 may analyze the doppler shift to adjust for frequency changes caused by relative motion between the terminal device and the network access node. Simultaneously, the processor 301 may account for sampling drift, which may result from clock inaccuracies or changes in distance between the terminal device and network access node. By compensating for both doppler shift and sampling drift, processor 301 may ensure that communication signals are accurately encoded or decoded, maintaining synchronization and preventing interference.

In some examples, after determining the doppler shift and sampling drift, the processor 301 may instruct a digital front end (DFE) of the network access node, which the communication interface 303 may include, to perform frequency conversion and data resampling based on these calculated values. The digital front end may be configured to convert received analog signals into digital form and vice versa. By adjusting the frequency conversion process according to the doppler shift, processor 301 may configure signals to properly align in frequency before they are processed further. Similarly, by instructing the digital front end to resample data based on the calculated sampling drift, processor 301 may correct timing discrepancies caused by clock inaccuracies or movement of the terminal device.

In some examples, the processor 301 may perform an inverse operation of both the signal doppler shift and sampling drift to mitigate their effects on communication signals. Specifically, this inverse operation may be designed to counteract two key issues: inter-carrier interference (ICI) within a single orthogonal frequency division multiplexing symbol and phase changes across multiple orthogonal frequency division multiplexing symbols. ICI occurs when frequency shifts caused by doppler effects result in an overlap between adjacent subcarriers within an orthogonal frequency division multiplexing symbol, degrading signal quality. By applying an inverse doppler shift operation, processor 301 may realign these subcarriers to reduce inter-carrier interference and improve signal clarity. Additionally, phase changes across multiple orthogonal frequency division multiplexing symbols can occur due to time shifts caused by sampling drift. By applying an inverse operation to account for this drift, processor 301 may maintain phase continuity across consecutive symbols to reduce errors in demodulation and improve overall communication reliability.

FIG. 9 shows an example of a block diagram in accordance with various aspects described herein, which may illustrate the process of doppler shift and sampling drift estimation and suppression for tracking the location of the terminal device in relation to the network access node. The processor 301 may perform operations described in this block diagram.

It is to be noted that the block diagrams described herein are examples used to illustrate various aspects of the operation of the processor 301 in relation to the terminal device and network access node. A person skilled in the art will recognize that these diagrams are presented on an exemplary basis, and certain blocks or steps may be omitted, combined, or modified depending on the specific implementation or system requirements. For instance, some blocks may represent intermediate processing steps that can be performed in different sequences or may not be necessary in all configurations. Additionally, the functionality of multiple blocks may be integrated into a single block or distributed across multiple components without departing from the scope. The diagrams are intended to provide a high-level understanding of the processes involved and should not be interpreted as limiting the scope of the claims.

In 901, the processor 301 may estimate the doppler shift and timing advance via the physical random access channel. The processor 301 may illustratively receive the physical random access channel preamble from the terminal device and perform hypothesis testing to estimate the doppler shift, which may account for the relative motion between the terminal and the network access node. The timing advance may be derived from the round trip time delay, which may represent the signal propagation time between the terminal device and the network access node.

Once these initial parameters are estimated, in 902, the processor 301 may perform an initial user equipment position acquisition. The processor 301 may use the doppler shift and round trip time delay to estimate the initial location of the terminal device within the coverage area. The processor 301 may calculate this initial position by analyzing how far and in what direction the terminal is located relative to the network access node.

In 903, after acquiring the initial position, the processor 301 may configure uplink transmissions for the terminal device. The processor 301 may receive the demodulation reference signal in these configured uplink transmissions from the terminal device and estimate both frequency offset and time offset. The frequency offset is caused by doppler effects due to relative motion, while time offset results from propagation delays or clock inaccuracies. These offsets can be critical for refining the initial position estimate and dynamically adjusting uplink transmission parameters to maintain synchronization between the terminal device and network access node.

Next, in block 904, the processor 301 may perform initial user equipment position tracking, which may include tracking the location of the user equipment. The processor 301 may continuously monitor changes in frequency and time offsets over time to track how the terminal device's location evolves. By comparing these new measurements with previous estimates, processor 301 may update its estimate of the terminal device's position as the terminal device and/or the network access node move relative to each other.

A second stage of processing can begin in 910, where the processor 301 may perform doppler shift and sampling drift estimation. The processor 301 may perform this estimation based on the output of the initial user equipment position acquisition (i.e. 902) and/or the initial user equipment position tracking (i.e. 904), which may involve calculating both doppler shift and sampling drift based on signal characteristics received from demodulation reference signal. Noting that the sampling drift may refer to variations in signal timing caused by clock inaccuracies or changes in distance between the terminal and the network access node, by estimating these parameters, the processor 301 may correct for any timing or frequency discrepancies that may affect uplink transmissions.

In 920, the processor 301 may apply a doppler shift and sampling drift suppression. This block may correct for both doppler-induced frequency shifts and sampling drift, ensuring that future uplink transmissions remain synchronized with other devices in the coverage area. The processor 301 may apply doppler shift and sampling drift suppression using known methods, leveraging the previously determined or tracked location of the terminal device. The processor 301 may apply doppler shift and sampling drift suppression. This may involve compensating for both doppler-induced frequency shifts and sampling drift to maintain accurate communication between the terminal device and network access node. The suppression process corrects for these effects by adjusting frequency conversion parameters and resampling data in real-time, ensuring that uplink transmissions are properly aligned with other devices in the coverage area. By continuously updating its estimates of doppler shift and sampling drift based on real-time data from demodulation reference signal signals, as well as tracking changes in location using physical random access channel preambles, the processor 301 may establish that communication remains synchronized even as terminal devices move within or across coverage areas.

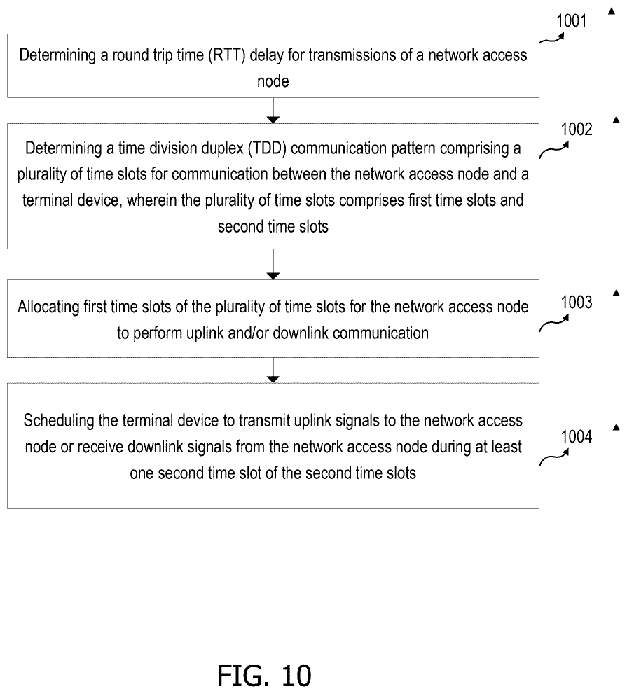

FIG. 10 shows an example of a method. The method 1000 may include: determining 1001 a round trip time delay for transmissions of a network access node; determining 1002 a time division duplex communication pattern may include a plurality of time slots for communication between the network access node and a terminal device, wherein the plurality of time slots include first and second time slots; allocating 1003 the first time slots of the plurality of time slots for the network access node to perform uplink and/or downlink communication with the terminal device; scheduling 1004 the terminal device to transmit uplink signals to the network access node or receive downlink signals from the network access node during at least one second time slot of the second time slots.

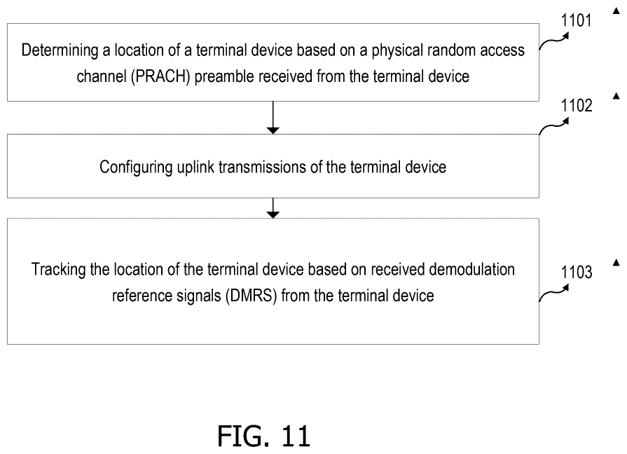

FIG. 11 shows an example of a method. The method 1100 may include: determining 1101 a location of a terminal device based on a physical random access channel (physical random access channel) preamble received from the terminal device; configuring 1102 uplink transmissions of the terminal device; and tracking 1103 the location of the terminal device based on received demodulation reference signals from the terminal device. A non-transitory computer-readable medium may include instructions which, if executed by a processor, cause the processor to perform the method 1100.

The following examples pertain to further aspects.

In example 1, the subject matter includes an apparatus that may include a processor configured to: determine a round trip time delay for transmissions of a network access node; determine a time division duplex communication pattern that may include a plurality of time slots for communication between the network access node and a terminal device, wherein the plurality of time slots include first and second time slots; allocate the first time slots of the plurality of time slots for the network access node to perform uplink and/or downlink communication with the terminal device; and schedule the terminal device to transmit uplink signals or receive downlink signals from the network access node during at least one second time slot of the second time slots.

In example 2, the subject matter of example 1 may further include that the processor may further be configured to allocate the second time slots of the plurality of time slots during which the network access node is scheduled to operate idle for communication with the terminal device.

In example, 3, the subject matter of example 2 may further include that the second time slots comprises a number of time slots that is based on the round-trip time delay.

In example 4, the subject matter of any one of examples 1 to 3, wherein the processor is further configured to schedule the terminal device to operate idle for communication with the network access node during at least one first time slot of the first time slots.

In example 5, the subject matter of example 4, wherein a number of time slots of the at least one first time slot is based on the round trip time delay.

In example 6, the subject matter of any one of examples 1 to 5, wherein the round trip time delay is determined based on a location of the terminal device.

In example 7, the subject matter of example 6, wherein the processor is configured to instruct the network access node to provide a network access service to multiple terminal devices may include the terminal device within a coverage area; wherein the round trip time delay is a common round trip time delay determined for the multiple terminal devices within the coverage area.

In example 8, the subject matter of example 7, wherein the common round trip time delay is the smallest round trip time delay among round trip time delays determined for the multiple terminal devices within the coverage area.

In example 9, the subject matter of example 7 or example 8, wherein the processor is further configured to determine a respective further round trip time delay for each terminal device of the multiple terminal devices within the coverage area; wherein a combination of the common round trip time delay and the respective further round trip time delay indicates a corresponding total round trip time delay of the respective terminal device.

In example 10, the subject matter of example 9, wherein the processor is further configured to estimate the respective further round trip time delay of the terminal device based on the location of the terminal device.

In example 11, the subject matter of example 9 or 10, wherein the processor is further configured to: estimate the respective further round trip time delay based on a received physical random access channel transmission from the terminal device; encode a random access message for a transmission of a random access response in response to the received physical random access channel transmission, wherein a timing advance value in the random access response is based on the round trip time delay.

In example 12, the subject matter of any one of examples 1 to 11, wherein the processor is further configured to calculate the number of second time slots by dividing the round trip time delay to a slot duration of the time division duplex communication pattern.

In example 13, the subject matter of any one of examples 1 to 12, wherein the first time slots include one or more consecutive uplink time slots and one or more consecutive downlink time slots; wherein the second time slots are provided between the one or more consecutive uplink time slots and the one or more consecutive downlink time slots.

In example 14, the subject matter of any one of examples 1 to 13, wherein the network access node is of a non-terrestrial network; wherein the network access node is a satellite access node or a satellite-based network access node.

In example 15, the subject matter includes an apparatus of a network access node, the apparatus may include a processor configured to: determine a location of a terminal device based on a physical random access channel preamble received from the terminal device; configure uplink transmissions of the terminal device; and track the location of the terminal device based on received demodulation reference signals from the terminal device.

In example 16, the subject matter of example 15, wherein the processor is further configured to: estimate a round trip time delay and a doppler shift associated with the physical random access channel preamble; determine the location of the terminal device by analyzing the round trip time delay and the doppler shift.

In example 17, the subject matter of example 15 or example 16, wherein the processor is further configured to: perform a hypothesis testing on the physical random access channel preamble using a plurality of doppler shift hypotheses, each doppler shift hypothesis being associated with a respective shift of received frequency symbols at a physical random access channel resource; estimate a respective frequency domain channel for the respective shift of received frequency symbols; and select one of the doppler shift hypothesis based on the respective frequency domain channel for each doppler shift hypothesis.

In example 18, the subject matter of example 17, wherein the processor is further configured to: convert the respective frequency domain channel to a corresponding time domain channel; identify a peak in the corresponding time domain channel; and determine the round trip time delay based on a location of the peak.

In example 19, the subject matter of example 18, wherein the processor is further configured to identify the peak by comparing an amplitude with a peak threshold.

In example 20, the subject matter of example 18 or 19, wherein the processor is further configured to determine the doppler shift by selecting one of the doppler shift hypothesis having the highest peak.

In example 21, the subject matter of example 18 or 19, wherein the processor is further configured to determine the doppler shift by calculating a linear combination of doppler shift hypotheses that generate the respective peaks that are above the peak threshold.

In example 22, the subject matter of any one of examples 15 to 21, wherein the processor is further configured to: estimate time offsets and frequency offsets from the received demodulation reference signal; determine changes in the estimated time offsets and frequency offsets; update the location of the terminal device based on the changes.

In example 23, the subject matter of example 22, wherein the processor is further configured to estimate a respective frequency offset from a respective received demodulation reference signal by performing conjugate multiplication between channel estimates of a same subcarrier across two different orthogonal frequency division multiplexing symbols.

In example 24, the subject matter of example 23, wherein the processor is further configured to estimate a respective time offset from the respective received demodulation reference signal by performing conjugate multiplication between channels on two different subcarriers within a same orthogonal frequency division multiplexing symbol.

In example 25, the subject matter of any one of examples 15 to 24, wherein the processor is further configured to determine at least one further location of the terminal device for tracking the location of the terminal device.

In example 26, the subject matter of example 25, wherein the processor is further configured to calculate a signal doppler shift and a sampling drift associated with a signal transmission between the network access node and the terminal device based on the at least one further location of the terminal device.

In example 27, the subject matter of example 25 or example 26, wherein the at least one further location is a last obtained location of the terminal device; wherein the processor is further configured to communicate with the terminal device by encoding or decoding a communication signal based on the calculated signal doppler shift and the sampling drift.

In example 28, the subject matter of any one of examples 26 to 27, wherein the processor is further configured to instruct a digital front end of the network access node to perform a frequency conversion and data resampling based on the calculated signal doppler shift and the sampling drift.

In example 29, the subject matter of any one of examples 26 to 28, wherein the processor is further configured to perform an inverse operation of the signal doppler shift and the sampling shift to cause an inter-carrier interference within a single orthogonal frequency division multiplexing symbol and to cause a phase change across multiple orthogonal frequency division multiplexing symbols of the communication signal.

In example 30, the subject matter of any one of examples 15 to 29, wherein the network access node is of a non-terrestrial network; wherein the network access node is a satellite access node or a satellite-based network access node.

In example 31, the subject matter of example 30, wherein a location determination of the terminal device is based on a location of the network access node and/or a satellite within the non-terrestrial network.

In example 32, the subject matter includes a method may include: determining a round trip time delay for transmissions of a network access node; determining a time division duplex communication pattern may include a plurality of time slots for communication between the network access node and a terminal device, wherein the plurality of time slots include first and second time slots; allocating the first time slots of the plurality of time slots for the network access node to perform uplink and/or downlink communication with the terminal device; scheduling the terminal device to transmit uplink signals to the network access node or receive downlink signals from the network access node during at least one second time slot of the second time slots.

In example 33, the subject matter of example 32 may further include allocating the second time slots of the plurality of time slots during which the network access node is scheduled to operate idle for communication with the terminal device.

In example 34, the subject matter of example 33 may further include that the second time slots comprises a number of time slots that is based on the round-trip time delay.

In example 35, the subject matter of any one of examples 32 to 34, may further include scheduling the terminal device to operate idle for communication with the network access node during at least one first time slot of the first time slots.

In example 36, the subject matter of example 35, further may include: scheduling the terminal device to perform neither uplink communication nor downlink communication with the network access node during at least one first time slot of the first time slots.

In example 37, the subject matter of example 36, wherein a number of time slots of the at least one first time slot is based on the round trip time delay.

In example 38, the subject matter of any one of examples 32 to 37, wherein the round trip time delay is determined based on a location of the terminal device.

In example 39, the subject matter of example 38, further may include: instructing the network access node to provide a network access service to multiple terminal devices may include the terminal device within a coverage area; wherein the round trip time delay is a common round trip time delay determined for the multiple terminal devices within the coverage area.

In example 40, the subject matter of example 39, wherein the common round trip time delay is the smallest round trip time delay among round trip time delays determined for the multiple terminal devices within the coverage area.

In example 41, the subject matter of example 39 or example 40, further may include: determining a respective further round trip time delay for each terminal device of the multiple terminal devices within the coverage area; wherein a combination of the common round trip time delay and the respective further round trip time delay indicates a corresponding total round trip time delay of the respective terminal device.

In example 42, the subject matter of example 41, further may include: estimating the respective further round trip time delay of the terminal device based on the location of the terminal device.

In example 43, the subject matter of example 41 or 42, further may include: estimating the respective further round trip time delay based on a received physical random access channel transmission from the terminal device; encoding a random access message for a transmission of a random access response in response to the received physical random access channel transmission, wherein a timing advance value in the random access response is based on the round trip time delay.

In example 44, the subject matter of any one of examples 32 to 43, wherein the first time slots include one or more consecutive uplink time slots and one or more consecutive downlink time slots; wherein the second time slots are provided between the one or more consecutive uplink time slots and the one or more consecutive downlink time slots.

In example 45, the subject matter of any one of examples 32 to 44, wherein the network access node is of a non-terrestrial network; wherein the network access node is a satellite access node or a satellite-based network access node.

In example 46, the subject matter includes a method for a network access node, the method may include: determining a location of a terminal device based on a physical random access channel preamble received from the terminal device; configuring uplink transmissions of the terminal device; and tracking the location of the terminal device based on received demodulation reference signals from the terminal device.

In example 47, the subject matter of example 46, further may include: estimating a round trip time delay and a doppler shift associated with the physical random access channel preamble; determining the location of the terminal device by analyzing the round trip time delay and the doppler shift.

In example 48, the subject matter of example 46 or example 47, further may include: performing a hypothesis testing on the physical random access channel preamble using a plurality of doppler shift hypotheses, each doppler shift hypothesis being associated with a respective shift of received frequency symbols at a physical random access channel resource; estimating a respective frequency domain channel for the respective shift of received frequency symbols; and selecting one of the doppler shift hypothesis based on the respective frequency domain channel for each doppler shift hypothesis.

In example 49, the subject matter of example 48, further may include: converting the respective frequency domain channel to a corresponding time domain channel; identifying a peak in the corresponding time domain channel; and determining the round trip time delay based on a location of the peak.

In example 50, the subject matter of example 49, further may include: identifying the peak by comparing an amplitude with a peak threshold.

In example 51, the subject matter of example 49 or 50, further may include: determining the doppler shift by selecting one of the doppler shift hypothesis having the highest peak.

In example 52, the subject matter of example 49 or 50, further may include: determining the doppler shift by calculating a linear combination of doppler shift hypotheses that generate the respective peaks that are above the peak threshold.

In example 53, the subject matter of any one of examples 46 to 52, further may include: estimating time offsets and frequency offsets from the received demodulation reference signal; determining changes in the estimated time offsets and frequency offsets; updating the location of the terminal device based on the changes.

In example 54, the subject matter of example 53, further may include: estimating a respective frequency offset from a respective received demodulation reference signal by performing conjugate multiplication between channel estimates of a same subcarrier across two different orthogonal frequency division multiplexing symbols.

In example 55, the subject matter of example 54, further may include: estimating a respective time offset from the respective received demodulation reference signal by performing conjugate multiplication between channels on two different subcarriers within a same orthogonal frequency division multiplexing symbol.

In example 56, the subject matter of any one of examples 46 to 55, further may include: determining at least one further location of the terminal device for tracking the location of the terminal device.

In example 57, the subject matter of example 46, further may include: calculating a signal doppler shift and a sampling drift associated with a signal transmission between the network access node and the terminal device based on the at least one further location of the terminal device.

In example 58, the subject matter of example 56 or example 57, wherein the at least one further location is a last obtained location of the terminal device; wherein the method further includes: communicating with the terminal device by encoding or decoding a communication signal based on the calculated signal doppler shift and the sampling drift.

In example 59, the subject matter of any one of examples 57 to 58, further may include: instructing a digital front end of the network access node to perform a frequency conversion and data resampling based on the calculated signal doppler shift and the sampling drift.

In example 60, the subject matter of any one of examples 57 to 59, further may include: performing an inverse operation of the signal doppler shift and the sampling shift to cause an inter-carrier interference within a single orthogonal frequency division multiplexing symbol and to cause a phase change across multiple orthogonal frequency division multiplexing symbols of the communication signal.

In example 61, the subject matter of any one of examples 46 to 60, wherein the network access node is of a non-terrestrial network; wherein the network access node is a satellite access node or a satellite-based network access node.

In example 62, the subject matter of example 61, wherein a location determination of the terminal device is based on a location of the network access node and/or a satellite within the non-terrestrial network.

In example 63, the subject matter is a non-transitory computer-readable medium including instructions which, if executed by a processor, cause the processor to perform the method of any one of examples 32 to 62.

The words “plurality” and “multiple” in the description or the claims expressly refer to a quantity greater than one. The terms “group (of)”, “set [of]”, “collection (of)”, “series (of)”, “sequence (of)”, “grouping (of)”, etc., and the like in the description or in the claims refer to a quantity equal to or greater than one, i.e. one or more. Any term expressed in plural form that does not expressly state “plurality” or “multiple” likewise refers to a quantity equal to or greater than one.

Any vector and/or matrix notation utilized herein is exemplary in nature and is employed solely for purposes of explanation. Accordingly, the apparatuses and methods described herein accompanied by vector and/or matrix notation are not limited to being implemented solely using vectors and/or matrices, and that the associated processes and computations may be equivalently performed with respect to sets, sequences, groups, etc., of data, observations, information, signals, samples, symbols, elements, etc.

As used herein, “memory” is understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, registers, shift registers, processor registers, data buffers, etc., are also embraced herein by the term memory. A single component referred to as “memory” or “a memory” may be composed of more than one different type of memory, and thus may refer to a collective component including one or more types of memory. Any single memory component may be separated into multiple collectively equivalent memory components, and vice versa. Furthermore, while memory may be depicted as separate from one or more other components (such as in the drawings), memory may also be integrated with other components, such as on a common integrated chip or a controller with an embedded memory.

The term “software” refers to any type of executable instruction, including firmware.

In the context described herein, the term “process” may be used, for example, to indicate a method. Illustratively, any process described herein may be implemented as a method (e.g., a channel estimation process may be understood as a channel estimation method). Any process described herein may be implemented as a non-transitory computer readable medium including instructions configured, when executed, to cause one or more processors to carry out the process (e.g., to carry out the method).

Throughout the drawings, it should be noted that like reference numbers are used to depict the same or similar elements, features, and structures, unless otherwise noted. It should be noted that certain components may be omitted for the sake of simplicity.

The phrase “at least one” and “one or more” may be understood to include a numerical quantity greater than or equal to one (e.g., one, two, three, four, [. . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [. . . ], etc.).

As used herein, a signal or information that is “indicative of”, “representative”, “representing”, or “indicating” a value or other information may be a digital or analog signal that encodes or otherwise, communicates the value or other information in a manner that can be decoded by and/or cause a responsive action in a component receiving the signal. The signal may be stored or buffered in computer-readable storage medium prior to its receipt by the receiving component and the receiving component may retrieve the signal from the storage medium. Further, a “value” that is “indicative of” or “representative” some quantity, state, or parameter may be physically embodied as a digital signal, an analog signal, or stored bits that encode or otherwise communicate the value.

As used herein, a signal may be transmitted or conducted through a signal chain in which the signal is processed to change characteristics such as phase, amplitude, frequency, and so on. The signal may be referred to as the same signal even as such characteristics are adapted. In general, so long as a signal continues to encode the same information, the signal may be considered as the same signal. For example, a transmit signal may be considered as referring to the transmit signal in baseband, intermediate, and radio frequencies.

The terms “processor” or “controller” as, for example, used herein may be understood as any kind of technological entity that allows handling of data. The data may be handled according to one or more specific functions executed by the processor. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, central processing unit, graphics processing unit, digital signal processor, field programmable gate array, integrated circuit, application specific integrated circuit, etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The terms “one or more processors” is intended to refer to a processor or a controller. The one or more processors may include one processor or a plurality of processors. The terms are simply used as an alternative to the “processor” or “controller”.

The term “user device” is intended to refer to a device of a user (e.g. occupant) that may be configured to provide information related to the user. The user device may exemplarily include a mobile phone, a smart phone, a wearable device (e.g. smart watch, smart wristband), a computer, etc.

As utilized herein, terms “module”, “component,” “system,” “circuit,” “element,” “slice,” “circuit,” and the like are intended to refer to a set of one or more electronic components, a computer-related entity, hardware, software (e.g., in execution), and/or firmware. For example, circuit or a similar term can be a processor, a process running on a processor, a controller, an object, an executable program, a storage device, and/or a computer with a processing device. By way of illustration, an application running on a server and the server can also be circuit. One or more circuits can reside within the same circuit, and circuit can be localized on one computer and/or distributed between two or more computers. A set of elements or a set of other circuits can be described herein, in which the term “set” can be interpreted as “one or more”.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art. The term “data item” may include data or a portion of data.

It will be understood that when an element is referred to as being “connected” or “coupled” to another element, it can be physically connected or coupled to the other element such that current and/or electromagnetic radiation (e.g., a signal) can flow along a conductive path formed by the elements. Inherently, such element is connectable or couplable to the another element. Intervening conductive, inductive, or capacitive elements may be present between the element and the other element when the elements are described as being coupled or connected to one another. Further, when coupled or connected to one another, one element may be capable of inducing a voltage or current flow or propagation of an electro-magnetic wave in the other element without physical contact or intervening components. Further, when a voltage, current, or signal is referred to as being “provided” to an element, the voltage, current, or signal may be conducted to the element by way of a physical connection or by way of capacitive, electro-magnetic, or inductive coupling that does not involve a physical connection.

Unless explicitly specified, the term “instance of time” refers to a time of a particular event or situation according to the context. The instance of time may refer to an instantaneous point in time, or to a period of time which the particular event or situation relates to.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

While the above descriptions and connected figures may depict electronic device components as separate elements, skilled persons will appreciate the various possibilities to combine or integrate discrete elements into a single element. Such may include combining two or more circuits to form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method. All acronyms defined in the above description additionally hold in all claims included herein.

What is claimed is:

1. An apparatus comprising: a memory; and a processor configured to:
determine a round-trip time delay for transmissions of a network access node;
determine a time division duplex communication pattern comprising a plurality of time slots for communication between the network access node and a terminal device, wherein the plurality of time slots include first and second time slots;
allocate the first time slots of the plurality of time slots for the network access node to perform uplink and/or downlink communication with the terminal device; and
schedule the terminal device to transmit uplink signals to or receive downlink signals from the network access node during at least one second time slot of the second time slots.

2. The apparatus of claim 1,
wherein the processor is further configured to allocate the second time slots of the plurality of time slots during which the network access node is scheduled to operate idle for communication with the terminal device.

3. The apparatus of claim 2,
wherein the second time slots comprises a number of time slots based on the round-trip time delay.

4. The apparatus of claim 1,
wherein the processor is further configured to schedule the terminal device to operate idle for with the network access node during at least one first time slot of the first time slots.

5. The apparatus of claim 4,
wherein a number of time slots of the at least one first time slot is based on the round trip time delay.

6. The apparatus of claim 1,
wherein the round trip time delay is determined based on a location of the terminal device;
wherein the processor is configured to instruct the network access node to provide a network access service to multiple terminal devices comprising the terminal device within a coverage area; and
wherein the round trip time delay is a common round trip time delay determined for the multiple terminal devices within the coverage area.

7. The apparatus of claim 6,
wherein the processor is further configured to determine the location of the terminal device based on a determined doppler shift for the terminal device.

8. The apparatus of claim 1,
wherein the first time slots comprise one or more consecutive uplink time slots and one or more consecutive downlink time slots; and
wherein the second time slots are provided between the one or more consecutive uplink time slots and the one or more consecutive downlink time slots.

9. The apparatus of claim 1,
wherein the network access node is of a non-terrestrial network; and
wherein the network access node is a satellite access node or a satellite-based network access node.

10. An apparatus, comprising: a memory; and a processor configured to:
determine a location of a terminal device based on a physical random access channel preamble received from the terminal device;
configure uplink transmissions of the terminal device; and
track the location of the terminal device based on received demodulation reference signals from the terminal device.

11. The apparatus of claim 10,
wherein the processor is further configured to:
estimate a round trip time delay and a doppler shift associated with the physical random access channel preamble; and
determine the location of the terminal device by analyzing the round trip time delay and the doppler shift.

12. The apparatus of claim 11,
wherein the processor is further configured to:
perform a hypothesis testing on the physical random access channel preamble using a plurality of doppler shift hypotheses, each doppler shift hypothesis of the plurality of doppler shift hypotheses being associated with a respective shift of received frequency symbols at a physical random access channel resource;
estimate a respective frequency domain channel for the respective shift of received frequency symbols; and
select one of the doppler shift hypothesis based on the respective frequency domain channel for each doppler shift hypothesis.

13. The apparatus of claim 12,
wherein the processor is further configured to:
convert the respective frequency domain channel to a corresponding time domain channel;
identify a peak in the corresponding time domain channel; and
determine the round trip time delay based on a location of the peak.

14. The apparatus of claim 13,
wherein the processor is further configured to identify the peak by comparing an amplitude with a peak threshold.

15. The apparatus of claim 10,
wherein the processor is further configured to:
estimate time offsets and frequency offsets from the received demodulation reference signals;
determine changes in the estimated time offsets and frequency offsets; and
update the location of the terminal device based on the changes.

16. The apparatus of claim 15,
wherein the processor is further configured to estimate a respective frequency offset from a respective received demodulation reference signal by performing conjugate multiplication between channel estimates of a same subcarrier across two different orthogonal frequency division multiplexing symbols.

17. The apparatus of claim 16,
wherein the processor is further configured to estimate a respective time offset from the respective received demodulation reference signal by performing conjugate multiplication between channels on two different subcarriers within a same orthogonal frequency division multiplexing symbol.

18. The apparatus of claim 10,
wherein the processor is further configured to determine at least one further location of the terminal device for tracking the location of the terminal device; and
wherein the processor is further configured to calculate a signal doppler shift and a sampling drift associated with a signal transmission between the network access node and the terminal device based on the at least one further location of the terminal device.

19. A non-transitory computer-readable medium comprising instructions which, if executed by a processor, cause the processor to:
determine a location of a terminal device based on a physical random access channel preamble received from the terminal device;
configure uplink transmissions of the terminal device; and
track the location of the terminal device based on received demodulation reference signals from the terminal device.

20. The non-transitory computer-readable medium of claim 19, wherein the instructions further cause the processor to:
estimate a round trip time delay and a doppler shift associated with the physical random access channel preamble; and
determine the location of the terminal device by analyzing the round trip time delay and the doppler shift.
